(19) United States
(12) Patent Application Publication
(10) Pub. No.: US 2013/0219050 A1
(43) Pub. Date: Aug. 22, 2013

(54) CLOUD SERVICE ACCESS APPARATUS, CLOUD SERVICE ACCESS METHOD, AND CLOUD SERVICE ACCESS SYSTEM

(71) Applicant: Pantech Co., Ltd., (US)

(72) Inventors: Jin Man Park, Seoul (KR); Young Tak Cho, Seoul (KR)

(73) Assignee: PANTECH CO., LTD., Seoul (KR)

(21) Appl. No.: 13/669,951

(22) Filed: Nov. 6, 2012

(30) Foreign Application Priority Data
Feb. 22, 2012 (KR) 10-2012-0018008

(51) Int. Cl. G06F 15/173

(52) U.S. Cl. 709/224

(57) ABSTRACT

A method for controlling a cloud file includes determining whether a scanning file corresponding to the cloud file is available, obtaining the scanning file from a virtual folder storage unit of a terminal, identifying a cloud plug module (CPM) corresponding to a cloud service in which the cloud file is stored based on the scanning file, and accessing the cloud service through the CPM. A cloud service access apparatus includes a cloud service access unit including a CPM, a virtual folder storage unit to store a scanning file associated with the CPM, and a control unit to determine whether the scanning file corresponds to a cloud file, to obtain the scanning file from a virtual folder storage unit, to identify the CPM corresponding to a cloud service storing the cloud file based on the scanning file, and to access the cloud service through the CPM.

### CROSS-REFERENCE TO RELATED APPLICATION

This application claims priority from and the benefit under 35 U.S.C. §119(a) of Korean Patent Application No. 10-2012-0018008, filed on Feb. 22, 2012, which is hereby incorporated herein by reference for all purposes.

### BACKGROUND

1. Field

Exemplary embodiments of the present invention relate to an apparatus and method for accessing a cloud service.

2. Discussion of the Background

Cloud service may refer or correspond to a service that may enable a service user to store a content in a server and access the content through a network using various types of terminals, which may allow reading or sharing of a content irrespective of a time, a region, and an apparatus.

As the cloud services may be utilized as a content sharing platform between individuals, groups, and companies beyond its use as an individual web storage, the cloud service may be used more actively in various fields.

When the cloud services are used in various fields, cloud services being managed may be inter-operated in a closed manner to create an environment in which content sharing and cooperative operating may be feasible.

With the spread of cloud services, the number of client interfaces or software dedicated to the corresponding cloud services developed by service providers may be increasing. Accordingly, when a user seeks to use various cloud services, the user may install a client interface or software in a mobile terminal of the user to access a corresponding cloud service. However, since a mobile terminal may have a limited storage space, a memory capacity may present an issue.

Also, whenever a new cloud service is added, some time may be expended for a user to learn how to use a corresponding client interface or software due to different user environments for each cloud service.

When cloud services do not inter-operate to move a content between different cloud services, content stored in a first cloud service may need to be downloaded and uploaded in a second cloud service when the mobile terminal has a client interface or software that corresponds to the second cloud service. Further, the terminal of the user may need to obtain each client interface or software to access contents that may be stored in various cloud services.

### SUMMARY

Exemplary embodiments of the present invention provide an apparatus and method for accessing a cloud service.

Additional features of the invention will be set forth in the description which follows, and in part will be apparent from the description, or may be learned by practice of the invention.

Exemplary embodiments of the present invention provide a method for controlling a cloud file using a processor including determining, using the processor, whether a scanning file corresponding to the cloud file is available; obtaining the scanning file from a virtual folder storage unit of a terminal; identifying a cloud plug module (CPM) corresponding to a cloud service in which the cloud file is stored based on the scanning file; and accessing the cloud service through the CPM.

Exemplary embodiments of the present invention provide a method for uploading a local file including receiving a request for uploading the local file to a cloud service; determining whether a suitable CPM is present based on an upload condition; transmitting a first scanning file to the CPM; and accessing the cloud service via the CPM for uploading the local file.

Exemplary embodiments of the present invention provide a cloud service access apparatus including a cloud service access unit including a CPM; a virtual folder storage unit to store a scanning file associated with the CPM; and a control unit to determine whether the scanning file corresponds to a cloud file, to obtain the scanning file from a virtual folder storage unit, to identify the CPM corresponding to a cloud service storing the cloud file based on the scanning file, and to access the cloud service through the CPM.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrates a general cloud service access environment.

FIG. 2 is a block diagram illustrating a cloud service access apparatus according to an exemplary embodiment of the present invention.

FIG. 3 is a block diagram illustrating a cloud service access apparatus according to an exemplary embodiment of the present invention.

FIG. 4 is a diagram illustrating a configuration of a scanning file according to an exemplary embodiment of the present invention.

FIG. 5 is a diagram illustrating a configuration of a file information field according to an exemplary embodiment of the present invention.

FIG. 6 is a diagram illustrating a configuration of a general file information field according to an exemplary embodiment of the present invention.

FIG. 7 is a diagram illustrating a configuration of a cloud file information field according to an exemplary embodiment of the present invention.

FIG. 8 is a diagram illustrating a configuration of a cloud plug module information field according to an exemplary embodiment of the present invention.

FIG. 9 is a diagram illustrating a configuration of a cloud based information field according to an exemplary embodiment of the present invention.

FIG. 10 is a diagram illustrating a configuration of an application data field according to an exemplary embodiment of the present invention.

FIG. 11 is a diagram illustrating a configuration of a file availability field according to an exemplary embodiment of the present invention.

FIG. 12 is a diagram illustrating a configuration of a download file path field according to an exemplary embodiment of the present invention.

FIG. 13 is a diagram illustrating a configuration of a cloud plug module index field according to an exemplary embodiment of the present invention.

FIG. 14 is a diagram illustrating a configuration of a cloud characteristic field according to an exemplary embodiment of the present invention.

FIG. 15 is a diagram illustrating a scanning operation according to an exemplary embodiment of the present invention.

FIG. 16A and FIG. 16B are flowcharts illustrating a cloud service access method according to an exemplary embodiment of the present invention.

FIG. 17 is a diagram illustrating a downloading operation according to an exemplary embodiment of the present invention.

FIG. 18 is a flowchart illustrating a cloud service access method according to an exemplary embodiment of the present invention.

FIG. 19 is a diagram illustrating an uploading operation according to an exemplary embodiment of the present invention.

FIG. 20 is a flowchart illustrating a cloud service access method according to an exemplary embodiment of the present invention.

FIG. 21 is a diagram illustrating a deleting operation according to an exemplary embodiment of the present invention.

FIG. 22 is a flowchart illustrating a cloud service access method according to an exemplary embodiment of the present invention.

FIG. 23 is a block diagram illustrating a cloud service access system according to an exemplary embodiment of the present invention.

FIG. 24 is a block diagram illustrating a cloud service access apparatus according to an exemplary embodiment of the present invention.

FIG. 25 and FIG. 26 are block diagrams illustrating a cloud service access apparatus according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

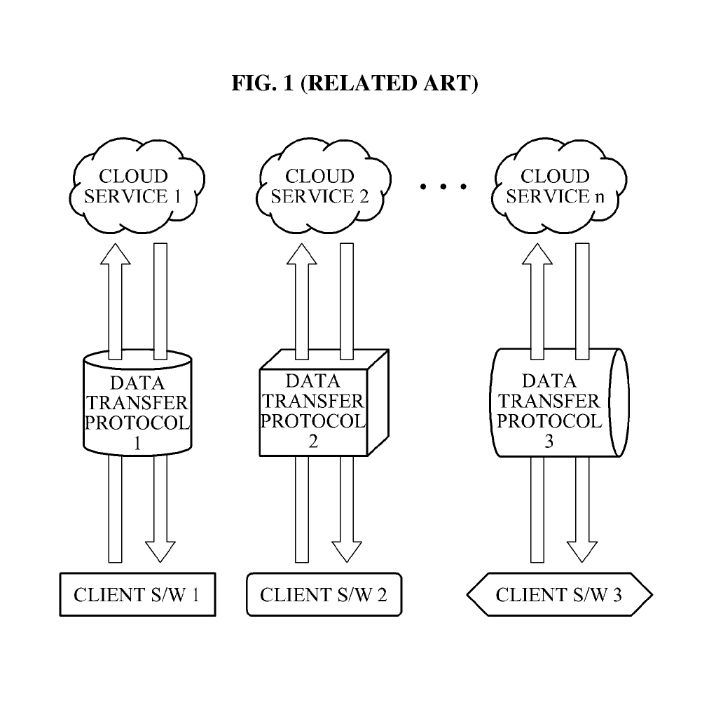

FIG. 1 is a diagram illustrates a general cloud service access environment.

Referring to FIG. 1, the general cloud service may be an access environment that may include one or more clouds to provide cloud services, a terminal accessible to the clouds, and client interfaces or software operating in the terminal. The terminal may include, without limitation, at least a smart phone, a tablet, a desk-top computer, an intelligent television (TV), and the like.

Further, client interface or software may generally be separated from each other. More specifically, cloud services may allow access through a dedicated client interface or software corresponding to its respective cloud service. A first cloud service 1 may allow an access using a first client software 1 corresponding to the first cloud service, but may not allow access when using a client interface or software of another cloud service, such as a second client software 2 or a third client software 3.

Further, as illustrated in FIG. 1, the first cloud service 1 may access the first client software 1 using a corresponding first data transfer protocol 1. The second client software 2 may access a second cloud service 2 using a corresponding second data transfer protocol 2. The third client software 3 may access a third cloud service 3 using a corresponding third data transfer protocol 3. The data transfer protocol 1, the data transfer protocol 2, and the data transfer protocol 3 may be different from one another.

A user may transmit or download a content to or from a cloud using a client software or interface. Also, the user may delete or modify a content on the cloud independent of the corresponding content that may be stored locally or at the client side. Accordingly, a content list on the cloud may not correspond to a list of contents stored locally or at the client side without updates.

A cloud service may be specialized or configured to accommodate one or more types of content, or may support one or more operations using various types of content. Each cloud service may use different data transfer protocols between a cloud service and a corresponding client software or interface for at least one of user authentication, content transmission, sharing content list reference, and the like.

A cloud service specialized or configured for various types of content may be understood through the following examples of related art.

For example, the first cloud service may be specialized or configured for a document sharing operation. The first cloud service may send and receive request and response signals to and from a client interface or software for conducting at least one of a service subscription operation, a user authentication operation, an operation to control a virtual folder list, a sharing operation for sharing document list reference, and a transferring or modification operation of a document. The operation to control the virtual folder list may include referencing, generating, deleting, or modifying an attribute, such as a name, of a virtual folder list.

In an example, in the content sharing operation, additional content information as shown in Table 1 below may be added to a data stream and transmitted using a hypertext transfer protocol (HTTP) postback (POST) method. The additional content information may be configured in a metadata format.

TABLE 1

| Metadata tag | Provided Information | Format |
|---|---|---|
| Magic number | Magic number | Binary |
| <content-title></content-title> | Title of content | Text |
| <content-file></content-file> | Name of actual file | Text |
| <author></author> | ID of first sharer/poster/uploader | Text |
| <date></date> | First uploaded date | Integer |
| <doc-ver></doc-ver> | Document version | Integer |
| <last-update></last-update> | Last updated date | Integer |
| <content-size></content-size> | Size of actual text data | Integer |
| Text data | Actual text data | Text |
| </eot> | End of transmission identifier | None |

For example, a second cloud service may be specialized or configured to share a video file or data. The second cloud service may send and receive request and response signals to and from a client interface or software for conducting a service subscription operation, a user authentication operation, an operation to control a virtual folder list, a sharing operation for sharing a video reference list, and a transferring or modification operation of a video file or data.

In the second cloud service, a separate data stream for age authentication using a HTTP POST method may be added as well as a data stream for video sharing.

The cloud service may use a file transfer protocol (FTP) in sharing a video file or data, and may transmit additional content information. For example, the additional content information associated with sharing of the video file or data may include information shown in Table 2 below. Further, the additional content information may be provided through a separate data stream of a HTTP POST method.

TABLE 2

| Metadata tag | Provided Information | Format |
|---|---|---|
| <movietitle></movietitle> | Title of content | Text |
| <filename></filename> | Name of actual file | Text |
| <filmedby></filmedby> | Film maker name | Text |
| <presentedby></presentedby> | Distributor name | Text |
| <copyrightinfo></copyrightinfo> | Copyright information | Text |
| <uploader></uploader> | ID of first sharer/poster/ | Text |
| | uploader | |
| <uploaddate></uploaddate> | First uploaded date | Integer |
| <runningtime></ruinningtime> | Total running time | Integer |
| <genre></genre> | Genre identifier | Integer |
| <director></director> | Director name | Text |
| <actor></actor> | Actor list | Text |
| <rating></rating> | Film rating identifier | Integer |

Also, when a separate subtitle file, for example, *.smi file and the like, is present, the subtitle file may be transmitted through a data stream of a HTTP POST method.

For example, an Nth cloud service may support various types of contents.

Like the first cloud service, the Nth cloud service may send and receive request and response signals to and from a client software or interface for at least one of an operation related to membership subscription, user authentication, virtual folder management, content list reference, and the like. However, a configuration of transmitted data may be different from that of the first cloud service.

The Nth cloud service may transmit a plurality of files through one data stream, and the data stream may be configured as shown in Table 3. Data and additional information may be included in the respective data stream. The Nth cloud service may define a data stream into bytes without using a separate tag for identifying data. Accordingly, the Nth cloud service may fix the size of metadata by recording data in a predetermined setting section and zero-padding the remaining space.

TABLE 3

| Metadata tag | Provided Information |
|---|---|
| 1 byte (first byte) | Number of files to be transmitted |
| 1024 bytes (from fifth byte) | Additional information of file 1 |
| Binary data | Actual data of file 1 |
| 1024 bytes | Additional information of file 2 |
| Binary data | Actual data of file 2 |
| And so on | . . . |
| 512 bytes | File name |
| 16 bytes | File size |
| 496 bytes | Advertising data recognizable by |
| | dedicated client S/W |

As detailed in the foregoing examples, cloud services may use different data transfer protocols and different data transfer procedures based on a type or objective of one or more services. More specifically, a first cloud service and a corresponding first client interface or software may be unable to interpret data transmitted from a second cloud service and a corresponding second client interface or software. Also, cloud services may have different configurations and different types of additional content information.

Since cloud services may have different protocols, the cloud services may be unable to share contents between the cloud services. A dedicated client interface or software may be provided to each corresponding cloud service, and when a user intends to use a cloud service with a terminal, the user may be unable to access the respective cloud service without installing a corresponding dedicated client interface or software in the terminal.

To use another cloud service, a corresponding dedicated client software or interface may be required to be installed. However, there may be a limitation in installing a number of dedicated client software in a terminal due to a limited storage space in the terminal Also, a user may be required to learn how to use a corresponding client due to different user environments for each cloud service. For at least these reasons, a more integrated system and method for accessing a cloud service may be desired.

Exemplary embodiments of the present invention may enable access a plurality of cloud services without installing a client software or interface dedicated to each cloud service, thereby reducing usage of a storage space of a terminal that may normally be used in installing a plurality of client software, and allowing a user to experience various cloud services using lesser number of access methods.

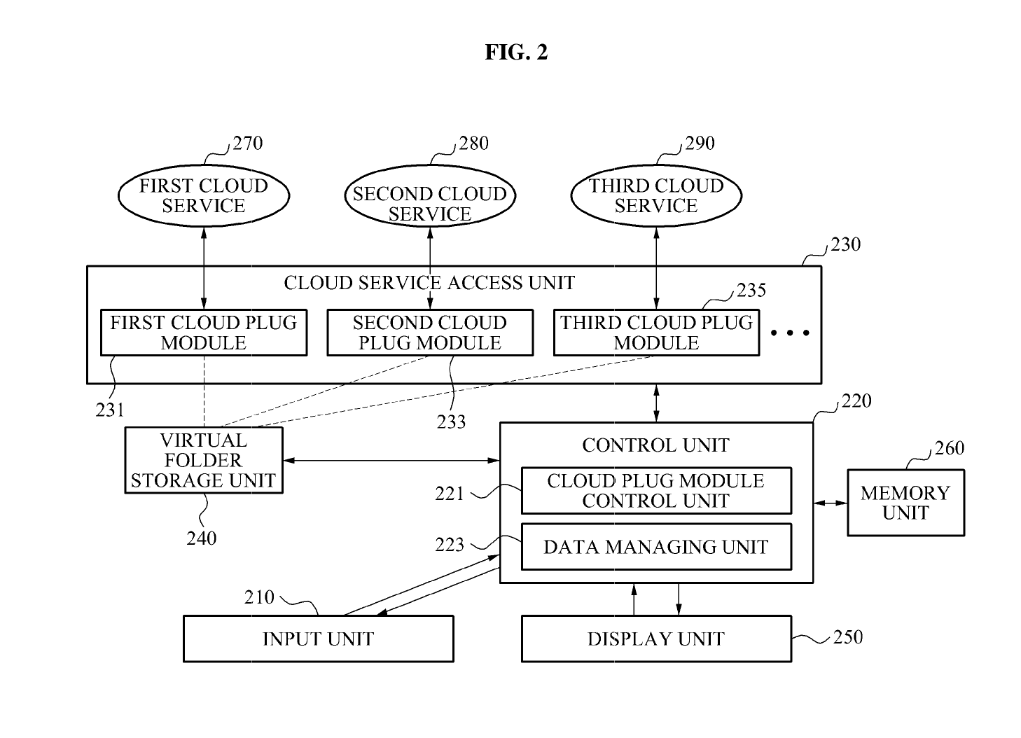

FIG. 2 is a block diagram illustrating a cloud service access apparatus according to an exemplary embodiment of the present invention.

Referring to FIG. 2, the cloud service access apparatus includes an input unit 210, a control unit 220, a cloud service access unit 230, a virtual folder storage unit 240, a display unit 250, and a memory unit 260.

The input unit 210 may receive a request to access at least one of a first cloud services 270, a second cloud service 280, and a third cloud service 290. The access request may include, without limitation, at least one of a scanning request, a reading and downloading request, an uploading request, and a deleting request.

The input unit 210 may receive an access request from a user through a mechanical input method and/or an electrical input method. For example, the mechanical input method may refer to pressing a button on the terminal to input the access request, and the electrical input method may refer to pressing a finger against a touch screen on the terminal to input the access request. However, aspects of the invention are not limited thereto, such that the access request may be received through a voice prompt or motion recognition.

The scanning request may refer to a request to scan or search to identify a cloud file stored in at least one of the first cloud service 270, the second cloud service 280, and the third cloud service 290 to create a scanning file. The scanning file may include at least one of information associated with at least one of the first cloud service 270, the second cloud service 280, and the third cloud service 290. The scanning file may be used to determine at least one of a storage location of an actual file, a cloud service to which an actual file belongs, and whether an actual file is available.

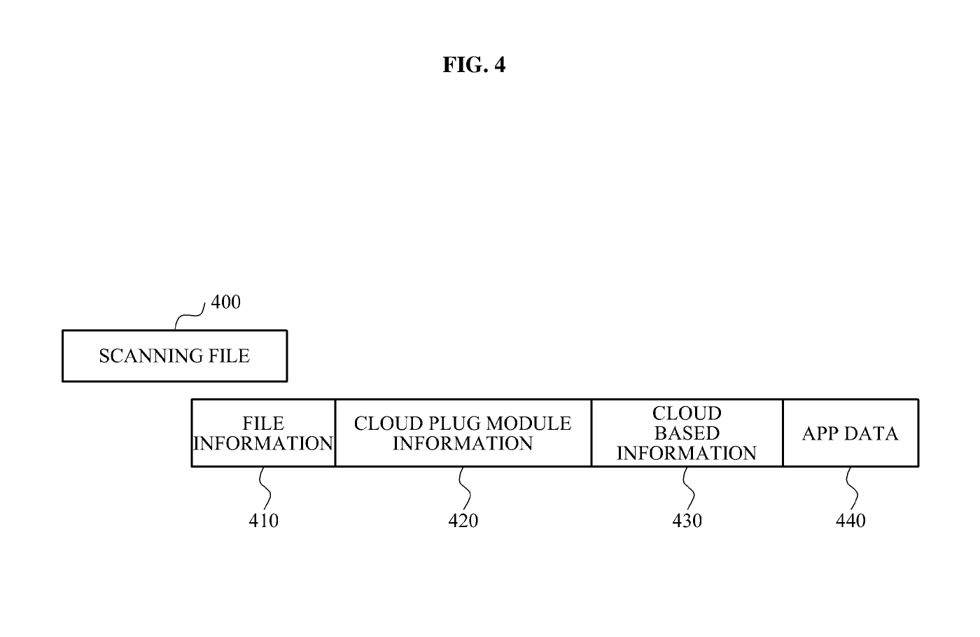

Also, the scanning file may include information associated with the file stored in at least one of the first cloud service 270, the second cloud service 280, and the third cloud service 290. Further, the scanning file may also include information used to access the first cloud service 270, the second cloud service 280, and the third cloud service 290. A configuration of the scanning file is described in further detail with reference to FIG. 4.

The control unit 220 may create or generate a scanning file or update an existing scanning file based on the access request. Also, the control unit 220 may control the cloud service access unit 230 based on information of the scanning file.

The control unit 220 may create or generate an empty scanning file and may store information associated with the cloud file stored in at least one of the first cloud service 270, the second cloud service 280, and the third cloud service 290 in the empty scanning file. The information associated with the cloud file may be obtained from the cloud file itself or from another source. Further, the control unit 220 may store at least a portion of a copy of the cloud file or information associated with the cloud file as a local file in the terminal. The scanning file may be created or generated by storing information associated with the cloud file in the empty scanning file or setting information associated with at least one of the first cloud service 270, the second cloud service 280, and the third cloud service 290 in the empty scanning file. Also, when the cloud file is modified or a change occurs in at least one of the corresponding first cloud service 270, second cloud service 280, and third cloud service, the control unit 220 may update the scanning file by reflecting the modification or the change on the scanning file.

The control unit 220 may control the operation of the cloud service access unit 230 based on a cloud plug module (CPM) index of the scanning file. The CPM index may correspond to an identity value of at least one of a first CPM 231, a second CPM 233, and a third CPM 235. The control unit 220 may use the CPM index to access the corresponding cloud services, including the first cloud service 270, the second cloud service 280, and the third cloud service 290.

The control unit 220 may include a CPM control unit 221 and a data managing unit 223.

The CPM control unit 221 may control at least one of the first CPM 231, the second CPM 233, and the third CPM 235 based on the access request and CPM information associated with the scanning file.

The cloud service access unit 230 may include the first CPM 231, the second CPM 233, and the third CPM 235. The first CPM 231, the second CPM 233, and the third CPM 235 may operate as client interface or software that can access the first cloud service 270, the second cloud service 280, and the third cloud service 290. The first CPM 231, the second CPM 233, and the third CPM 235 may each be assigned to the first cloud service 270, the second cloud service 280, and the third cloud service 290, respectively.

For example, the first CPM 231, the second CPM 233, and the third CPM 235 may be used to access the first cloud service 270, the second cloud service 280, and the third cloud service 290, respectively. At least one of the first CPM 231, the second CPM 233, and the third CPM 235 may obtain file information of the scanning file in the process of accessing at least one of the first cloud services 270, the second cloud service 280, and the third cloud service 290, respectively.

The data managing unit 223 may create an empty scanning file when a scanning file corresponding to the access request is absent or unavailable. For example, the data managing unit 223 may create an empty scanning file to scan a cloud file stored in the cloud service 270.

The scanning file or files may be stored in the virtual folder storage unit 240. The scanning files may be stored in a virtual folder included in the virtual folder storage unit 240 for one or more scanning files. For example, a scanning file to be downloaded or a scanning file to be deleted may be stored in a virtual folder. The scanning file may be stored in a virtual folder in a chronological order of download dates, alphabetical order of file names included in the scanning file, size of the scanning files, or the like. Also, the scanning files may be stored in a virtual folder for one or more related cloud service. For example, a first scanning file associated with the first cloud service 270 may be stored in a first virtual folder in the virtual folder storage unit 240, a second scanning file associated with the second cloud service 280 may be stored in a second virtual folder in the virtual folder storage unit 240, and a third scanning file associated with the third cloud service 290 may be stored in a third virtual folder in the virtual folder storage unit 240. Further, the scanning files stored in the virtual folders may be distinguished based on the CPM index information included in the scanning files.

The virtual folder may be displayed to the user through the display unit 250. The virtual folder storage unit 240 may classify and store the scanning files in a hierarchical structure based on information associated with the respective scanning file. However, aspects of the invention are not limited thereto, such that the scanning files may be stored in a grouping structure, similar structures, or without any structure.

The display unit 250 may display the virtual folder of a hierarchical structure. The user may check a cloud file stored in the first cloud service 270, the second cloud service 280, and the third cloud service 290 by checking file information of the stored file through the scanning file in the virtual folder.

When a scanning file corresponding to the access request is determined to be present, the data managing unit 223 may download the respective scanning file from the virtual folder storage unit 240. The data managing unit 223 may transmit the access request to the CPM control unit 221 based on file information associated with the downloaded scanning file.

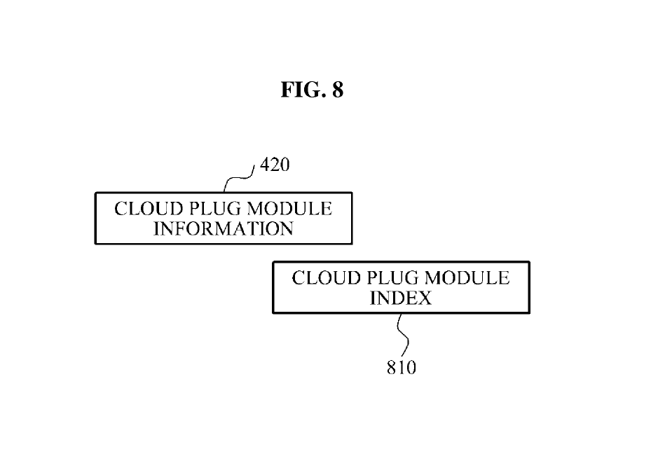

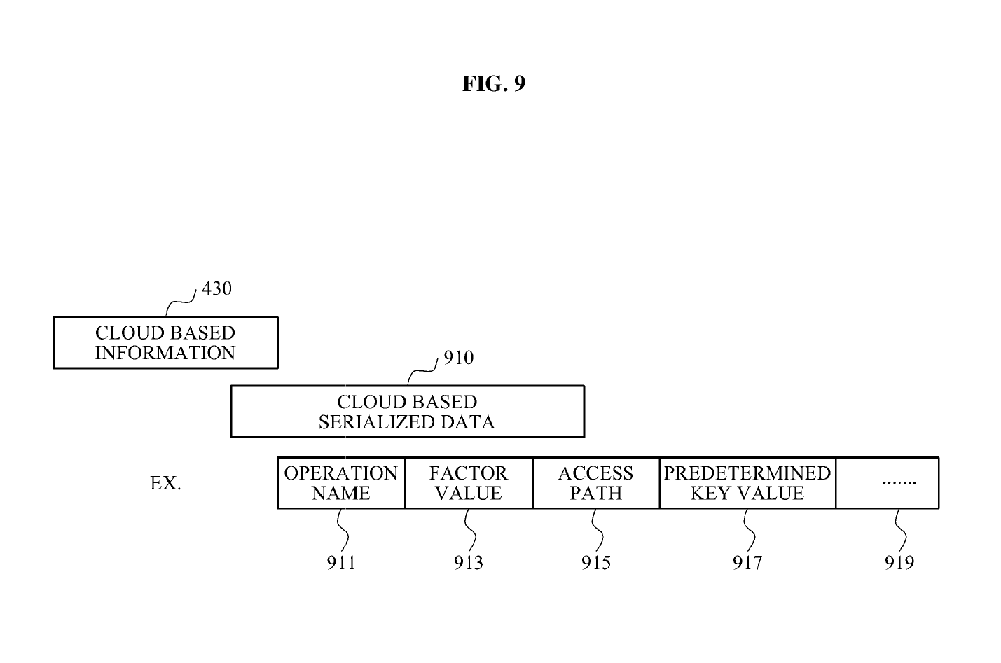

The cloud service access unit 230 may access at least one of the first cloud service 270, the second cloud service 280, and the third cloud service 290 based on information associated with the scanning file. The cloud service access unit 230 may access at least one of the first cloud service 270, the second cloud service 280, and the third cloud service 290 using CPM information and cloud based information of the scanning file. The CPM information may be described in further detail with reference to FIG. 8, and the cloud based information is described in further detail with reference to FIG. 9.

Also, the cloud service access unit 230 may access at least one of the first cloud service 270, the second cloud service 280, and the third cloud service 290 in response to the access request.

At least one of the first CPM 231, the second CPM 233, and the third CPM 235 may each operate as a client of at least one of the first cloud service 270, the second cloud service 280, and the third cloud service 290.

The display unit 250 may display file information associated with the cloud file stored in at least one of the first cloud service 270, the second cloud service 280, and the third cloud service 290 in response to the access request.

For example, when a scanning request is inputted through the input unit 210, the display unit 250 may display file information associated with the scanning file corresponding to at least one of the first cloud service 270, the second cloud service 280, and the third cloud service 290.

The displayed file information is stored in the scanning file. Thus, even though a cloud file may not be stored or downloaded in the terminal, information associated with the cloud file stored in at least one of the first cloud service 270, the second cloud service 280, and the third cloud service 290 may be checked.

The memory unit 260 may store a local file corresponding to a cloud file or information associated with the cloud file, which may be downloaded from at least one of the first cloud service 270, the second cloud service 280, and the third cloud service 290. Also, an upload file to be uploaded may be stored in the memory unit 260.

The cloud service access apparatus may integratedly manage the plurality of cloud services, including the first cloud service 270, the second cloud service 280, and the third cloud service 290, by using a scanning file. The cloud service access apparatus may integratedly manage the plurality of cloud services, including the first cloud service 270, the second cloud service 280, and the third cloud service 290 on a network by creating different formats of cloud files stored in the first cloud service 270, the second cloud service 280, and the third cloud service 290 as scanning files may have the same or similar format.

The cloud service access apparatus may be mounted in the terminal as one module or various modules. However, aspects of the invention are not limited thereto, such that the cloud service access apparatus may be accessed via a network.

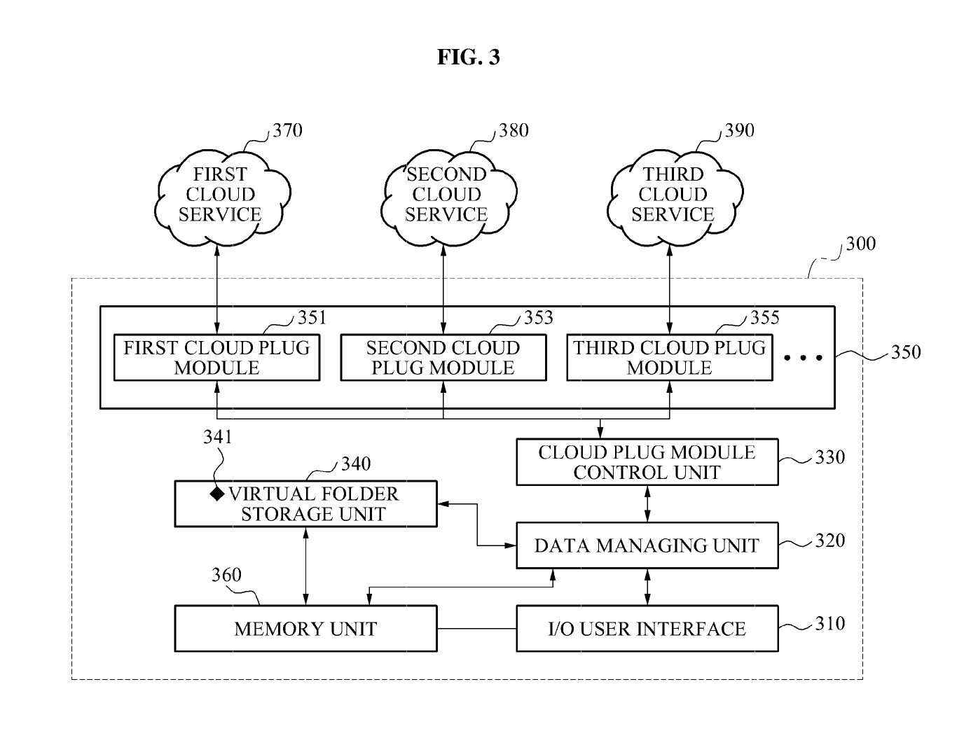

FIG. 3 is a block diagram illustrating a cloud service access apparatus 300 according to an exemplary embodiment of the present invention.

The exemplary embodiment of FIG. 3 may have a different configuration from FIG. 2 with respect to operations associated with input and output, data management, and CPM control. In FIG. 3, unlike FIG. 2, input and output may be performed through a single component, such as an input/output (I/O) user interface 310. A data managing unit 320 and a CPM control unit 330 may not be included in the control unit 220 and may be implemented as separate modules.

Referring to FIG. 3, the cloud service access apparatus 300 includes an I/O user interface 310, a data managing unit 320, a CPM control unit 330, a virtual folder storage unit 340, a cloud service access unit 350, and a memory unit 360.

The I/O user interface 310 may receive an input of a signal from a user, and may output file information and a content of a cloud file stored in a first cloud service 370, a second cloud service 380, and a third cloud service 390 in response to a request by the user.

The data managing unit 320 may be connected to the CPM control unit 330 to perform an operation associated with the cloud file stored in at least one of the first cloud service 370, the second cloud service 380, and the third cloud service 390. The operation performed on the cloud file may include, without limitation, at least one of scanning, reading, downloading, uploading, and deleting the cloud file. The data managing unit 320 may be connected to the virtual folder storage unit 340 to display a hierarchical structure of virtual folder to the user through the I/O user interface 310.

The structure of virtual folder may be changed through the I/O user interface 310 and the changed structure of virtual folder may be reflected on the virtual folder storage unit 340 by support of the data managing unit 320. The data managing unit 320 may be connected to the memory unit 360 to transmit a downloaded local file to the memory unit 360 and read the local file from the memory unit 360. The data managing unit 320 may create an empty scanning file and may provide the empty scanning file to at least one of a first CPM 351, a second CPM 353, and a third CPM 355.

The cloud service access unit 350 may include at least one of the first CPM 351, the second CPM 353, and the third CPM 355. The first CPM 351 may access the first cloud service 370 to perform an operation on the cloud file stored in the first cloud service 370. The second CPM 353 may access the second cloud service 380 to perform an operation on the cloud file stored in the second cloud service 380. The third CPM 355 may access the third cloud service 390 to perform an operation on the file stored in the third cloud service 390. The operation performed on the actual file may include, without limitation, at least one of scanning, reading, downloading, uploading, and deleting the file.

The CPM control unit 330 may control the operation of at least one of the first CPM 351, the second CPM 353, and the third CPM 355 based on a scanning file 341. The data managing unit 320 may perform an operation on the scanning file 341. The scanning file 341 may be stored in the virtual folder storage unit 340 in a virtual folder. The virtual folder may be generated by arranging the scanning file 341 based on a predetermined standard. The memory unit 360 may be located inside or outside of the cloud service access apparatus 300. The operation performed on the scanning file 341 may include, without limitation, at least one of creating, storing, modifying, and deleting the scanning file 341.

The CPM control unit 330 may receive a request to perform, without limitation, at least one of a scanning operation, a reading operation, a downloading operation, an uploading operation, and a deleting operation from the data managing unit 320. Further, the CPM control unit 330 may search for at least one of the first CPM 351, the second CPM 353, and the third CPM 355 to perform an operation based on the scanning file 341.

When the CPM control unit 330 receives a request for performing an operation (e.g., reading, downloading, and/or deleting) on the scanning file 341, the CPM control unit 330 may search for the corresponding CPM amongst the first CPM 351, the second CPM 353, and the third CPM 355 using CPM information of the scanning file 341. Further, the CPM control unit 330 may request at least one of the corresponding CPM from the first CPM 351, the second CPM 353, and the third CPM 355 to perform an operation on the scanning file 341. In an example, when the CPM control unit 330 receives a request to upload the scanning file 341, the CPM control unit 330 may search for corresponding CPM amongst the first CPM 351, a second CPM 353, and a third CPM 355 based on a cloud characteristic and may request the corresponding CPM to perform an uploading operation.

The cloud service access unit 350 may include at least one of the first CPM 351, the second CPM 353, and the third CPM 355. However, the cloud service access unit 350 may increase or decrease the number of CPMs through a component addition or deletion operation. More specifically, a CPM may be added or deleted by managing the first CPM 351, the second CPM 353, and the third CPM 355 as an assembly of components. Accordingly, to access a new non-registered cloud service, a new corresponding CPM may be added to the cloud service access unit 350 as a component. Similarly, to delete a cloud service from the cloud service access unit 350, the respective CPM may be deleted from the cloud service access unit 350 as a component.

At least one of the first CPM 351, the second CPM 353, and the third CPM 355 may operate as a client interface or software of the first cloud service 370, the second cloud service 380, and the third cloud service 390 on the web.

FIG. 4 is a diagram illustrating a configuration of a scanning file 400 according to an exemplary embodiment of the present invention.

Referring to FIG. 4, the scanning file 400 includes a file information field 410, a CPM information field 420, a cloud based information field 430, and an application data field 440. The scanning file 400 may be created by virtualizing one or more cloud files stored in the cloud services. More specifically, the scanning file 400 may be recognized as a virtual file corresponding to a cloud file stored in the corresponding cloud service by including information associated with the cloud file.

The file information field 410 may include information associated with the cloud file stored in a cloud service. The CPM information field 420 may include information about one or more CPMs that can access the cloud service. The cloud based information field 430 may include information associated with a predetermined method used to access the cloud services using the corresponding CPMs. The application data field 440 may include application data that may not have a file format, such as web application data supported by a web service. For example, the web service may include, without limitation, a blog, Twitter®, Facebook®, Google Earth®, Foursquare®, and the like. The web application data may include at least one of a feed, web page information, and the like, that may be used in the web service.

The scanning file 400 may be used in the data managing unit, the CPM control unit, and the CPM.

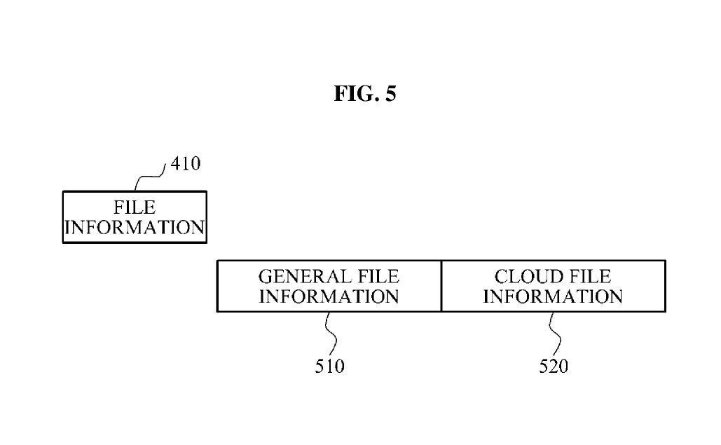

FIG. 5 is a diagram illustrating a configuration of the file information field 410 according to an exemplary embodiment of the present invention.

Referring to FIG. 5, the file information field 410 includes a general file information field 510 and a cloud file information field 520. The general file information field 510 may include information associated with a cloud file stored in the cloud services.

The cloud file information field 520 may include information associated with a scanning file.

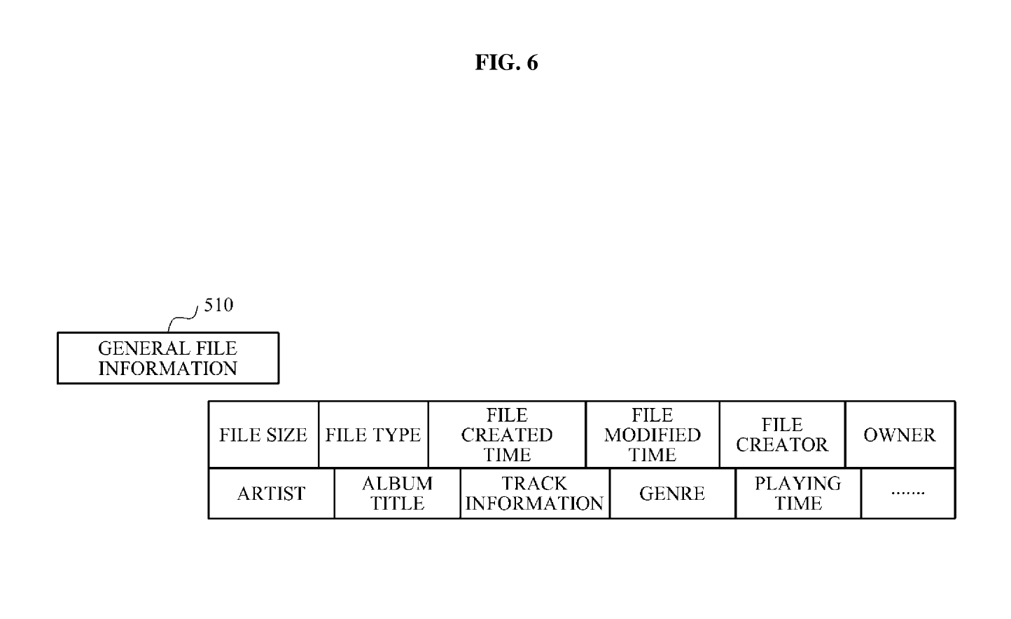

FIG. 6 is a diagram illustrating a configuration of the general file information field 510 according to an exemplary embodiment of the present invention.

Referring to FIG. 6, the general file information field 510 includes information associated with a file size, a file type, a file created time, a file modified time, a file creator, and an owner. Further, if the file is determined to be a music file, additional information about the music file including information associated with an artist, an album title, track information, a genre, a playing time, and the like is included in the general file information field 510. However, aspects of the invention are not limited thereto, such that the general file information field 510 may include a source information, a file history, and the like. Further, the cloud file may be a file related to an application, a movie, a web service, and the like.

The general file information field 510 may be used in providing information about the cloud file stored in the cloud services to the user through the I/O user interface.

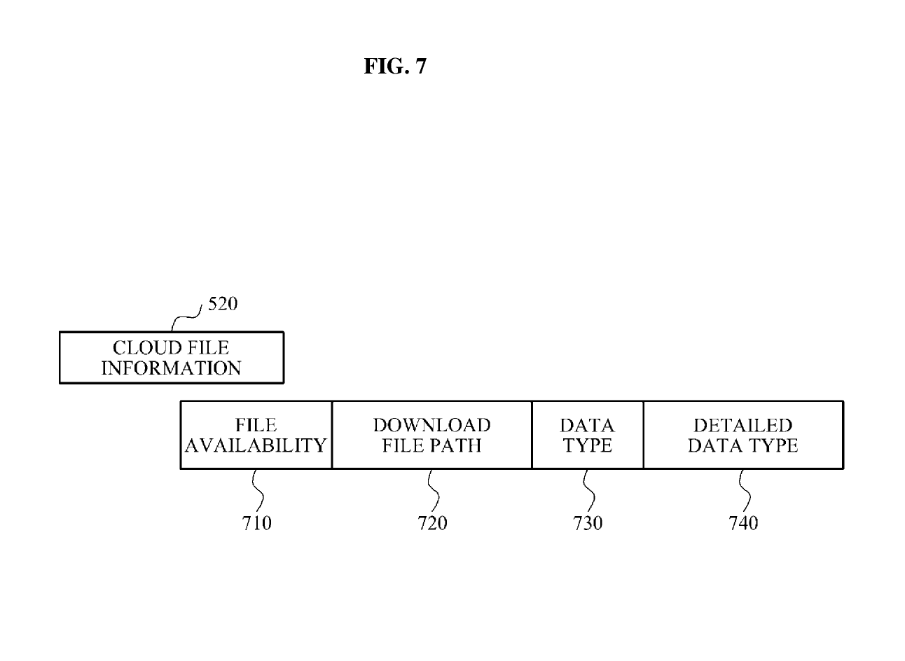

FIG. 7 is a diagram illustrating a configuration of the cloud file information field 520 according to an exemplary embodiment of the present invention.

Referring to FIG. 7, the cloud file information field 520 includes a file availability field 710, a download file path field 720, a data type field 730, and a detailed data type field 740.

The file availability field 710 may indicate whether a scanning file is available. The download file path field 720 may indicate a path through which a downloaded actual file may be stored in a memory unit of the terminal. The data type field 730 may indicate a data type of a cloud file used in reading a local file. The data type may be determined based on a file type of the general file information field. The detailed data type field 740 may indicate additional data type of a cloud file that may be used in reading a local file.

The data managing unit may use the cloud file information field 520 to manage the scanning file.

FIG. 8 is a diagram illustrating a configuration of the CPM information field 420 according to an exemplary embodiment of the present invention.

Referring to FIG. 8, the CPM information field 420 may include a CPM index field 810. The CPM index field 810 may indicate an identity value for identifying the CPMs.

The CPM control unit may use the CPM information field 420 to determine which CPM may perform an operation requested using the scanning file.

FIG. 9 is a diagram illustrating a configuration of the cloud based information field 430 according to an exemplary embodiment of the present invention.

Referring to FIG. 9, the cloud based information field 430 may indicate an assembly of values or information that may be used to access the cloud file of the cloud services via at least one of the CPMs.

The cloud based information may be based on an operation provided by the cloud services to implement the CPMs.

The cloud based information field 430 may include serialized data based on the cloud services. For example, the cloud based information field 430 may include an operation name 911 of an operation that may be used in accessing the cloud file, a factor value 913 used in the respective operation, an external access path 915 to an external server if an access to an external server is requested or performed, a predetermined value of promised key value 917 corresponding to one or more keys used between external servers, and other miscellaneous information 919.

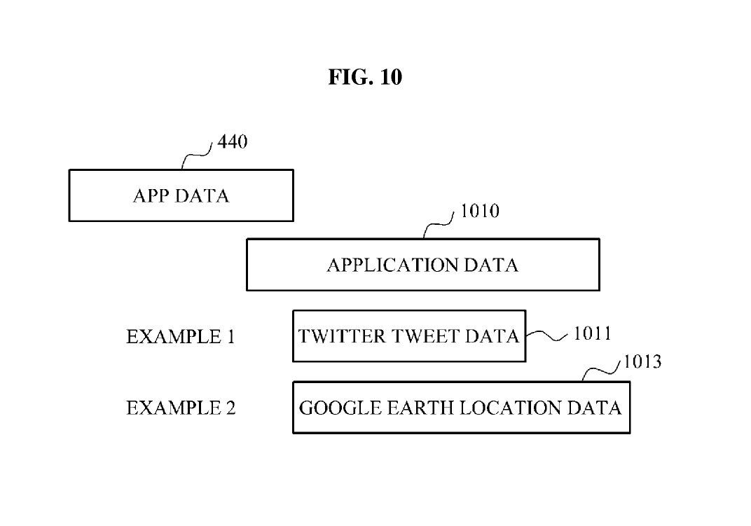

FIG. 10 is a diagram illustrating a configuration of the application data field 440 according to an exemplary embodiment of the present invention.

Referring to FIG. 10, the application data field 440 may correspond to data created on an application, which may be absent in a defined file format. This data may be defined application data 1010. The application data 1010 may not be stored in an external memory in the file since the application data 1010, in a defined file format, may be absent. The application data 1010 may be used in a file format by storing the application data 1010 in the scanning file.

The application data field 440 may be a section in which the downloaded application data 1010 may be stored. For example, the application data 1010 may include tweet data 1011 of Twitter® and Google Earth® location data 1013.

When the application data 1010 is stored in the application data field 440, a value indicating that the application data 1010 has been stored may be set in the file availability field.

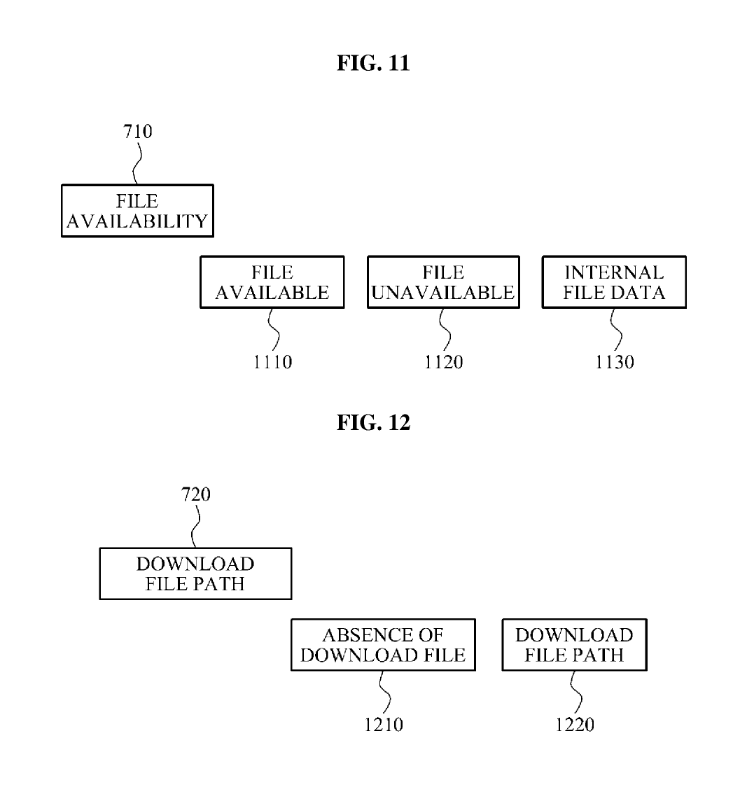

FIG. 11 is a diagram illustrating a configuration of the file availability field 710 according to an exemplary embodiment of the present invention.

Referring to FIG. 11, the file availability field 710 includes a file available field 1110 to indicate that one or more files may be available, a file unavailable field 1120 to indicate that one or more files may be absent or unavailable, and an internal file data field 1130. In an example, the internal file data field may include historical file availability information associated with the cloud file, or other information associated with the cloud file.

The file available field 1110 may indicate that a scanning file is available. When a value is set in the file available field 1110 indicating that the scanning file is available, the data managing unit may determine that both a scanning file and a corresponding cloud file are available and may perform a corresponding operation. The corresponding operations may include at least one of reading, downloading, and deleting.

When a value is set in the file unavailable field 1120 to indicate one or more files may be absent, the data managing unit may determine that a cloud file is unavailable. For example, when the cloud file is determined to be absent or that access to the cloud file may not possible through the cloud service, the data managing unit may delete the corresponding scanning file. However, aspects of the invention are not limited thereto, such that the data managing unit may determine whether a scanning file is unavailable.

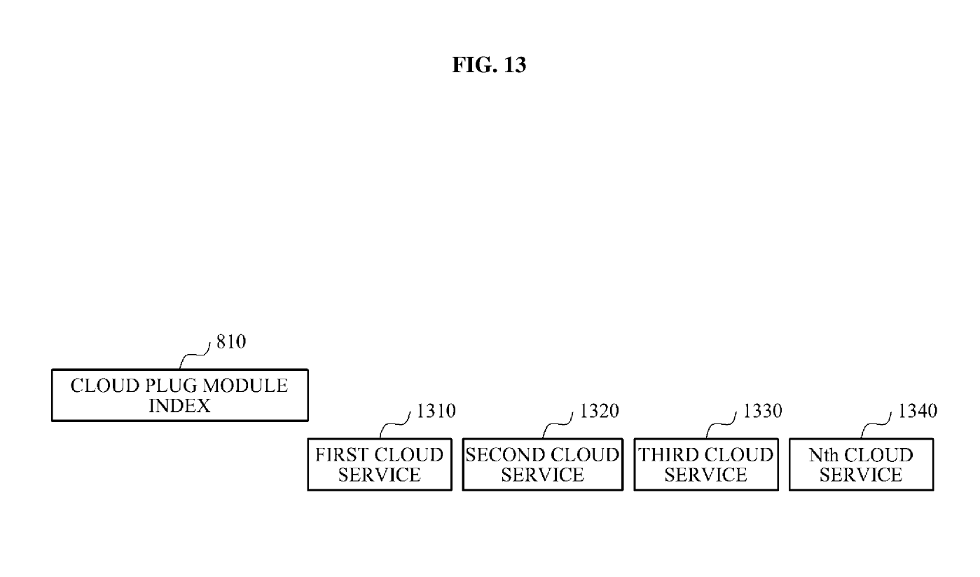

FIG. 12 is a diagram illustrating a configuration of the download file path field 720 according to an exemplary embodiment of the present invention.

Referring to FIG. 12, the download file path field 720 includes an absence of download file section 1210 to indicate a presence or an absence of a download file, and a download file path section 1220 to provide a download file path.

The download file path field 720 may be used when the data managing unit reads a cloud file using a scanning file.

The download file path value may indicate an access path through which a download file may be stored in a memory of a system or terminal. For example, in case of a window system, a file path, for example, C:\app\ may be set. In case of a web-based system, a file path of uniform resource indicator (URI) scheme, for example, http://host/path may be set.

When a value indicating the absence of a download file is set in the absence of download file section 1210, the data managing unit may request the CPM control unit to download a cloud file to perform a reading operation.

When a download file path value is set in the download file path section 1220, the data managing unit may download a file stored in the memory based on the download file path value to allow the user to read the downloaded file.

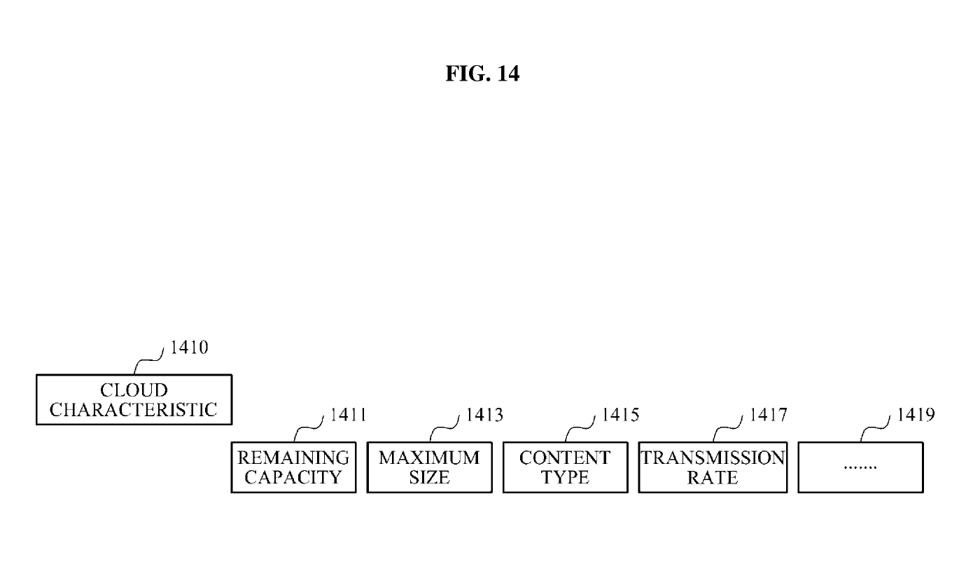

FIG. 13 is a diagram illustrating a configuration of the CPM index field 810 according to an exemplary embodiment of the present invention.

Referring to FIG. 13, the CPM index field 810 may store an identity value of one or more of the CPMs. For example, the identity value of the CPMs may be set to correspond to an identity value of the corresponding cloud services. The identity value of the CPMs may include at least one of an identity value of a first cloud service 1310, an identity value of a second cloud service 1320, an identity value of a third cloud service 1330, and an identity value of an Nth cloud service 1340. For example, a cloud service name, such as, SKYme, UPLUS, and Web Folder, may be set as the identity value of the CPM. Also, an identification (ID) and a password of the cloud service may be set as the identity value of the CPM. However, aspects of the invention are not limited thereto, such that the identity value of the CPMs may be a randomly generated number or alphanumeric characters, or a user designated values, which may be mapped to the corresponding cloud service.

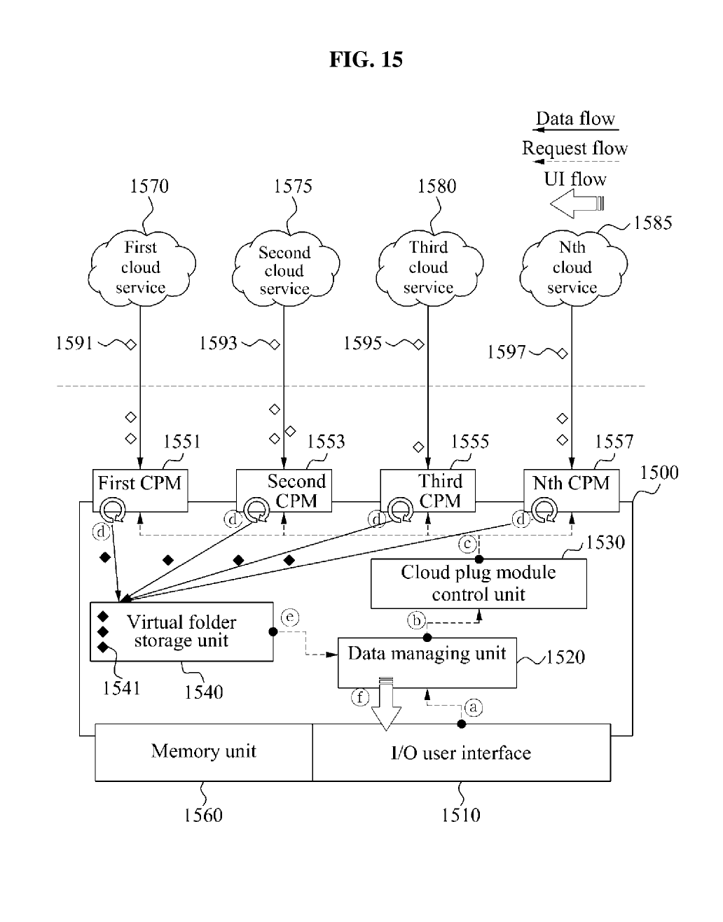

FIG. 14 is a diagram illustrating a configuration of a cloud characteristic field 1410 according to an exemplary embodiment of the present invention.

Referring to FIG. 14, the cloud characteristic field 1410 includes information associated with the cloud services, such as information on a remaining capacity 1411, a maximum size 1413, a content type 1415, a transmission rate 1417, and other miscellaneous information field 1419. Further, the cloud characteristic field 1410 may include information indicating a characteristic of each cloud service.

The maximum size 1413 may provide a storage capacity of the corresponding cloud service, and the content type 1415 may provide a type of a content supported by the corresponding cloud service.

The cloud characteristic field 1410 may be located in a scanning file, or may be located in one or more CPMs, separate from the scanning file.

The transmission rate field 1417 may provide information associated with a rate of data transmission of the corresponding cloud service. The other miscellaneous information field 1419 may include various information associated with the corresponding cloud service, such as, established date of the cloud service, owner of the cloud service, update history, number of connected devices, identify of the connected devices, and the like.

When the CPM control unit performs an uploading operation, the CPM control unit may refer to the cloud characteristic field 1410 to determine a cloud service in which the uploading operation is to be performed.

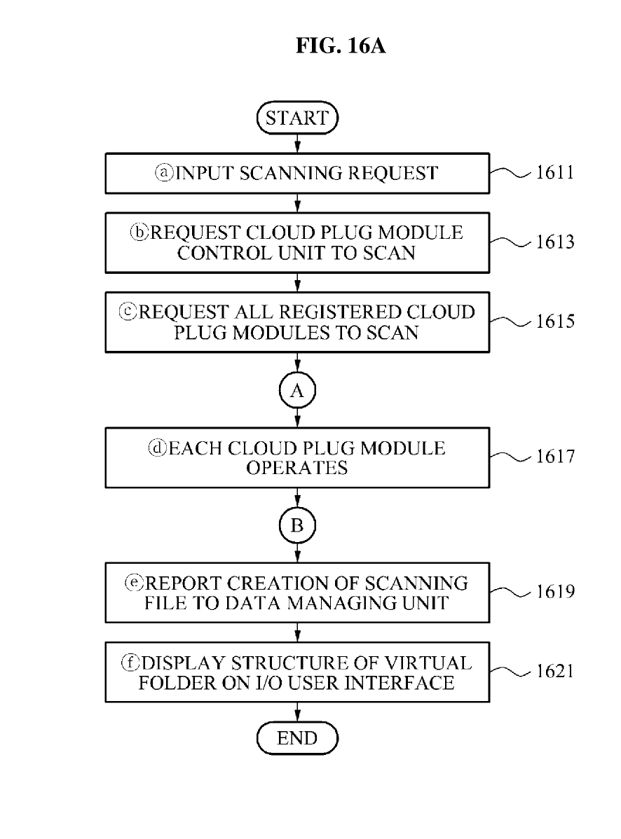

FIG. 15 is a diagram illustrating a scanning operation according to an exemplary embodiment of the present invention.

The scanning operation may refer to or correspond to collecting information associated with a file stored in the cloud services.

Referring to FIG. 15, when a scanning request is inputted by a user through an I/O user interface 1510, a data managing unit 1520 may transmit the scanning request to a CPM control unit 1530.

The CPM control unit 1530 may request at least one of the registered CPMs, including a first CPM 1551, a second CPM 1553, a third CPM 1555, and a Nth CPM 1557, to perform a scanning operation. The CPM control unit 1530 may request at least one of the CPMs among the registered CPMs, which includes the first CPM 1551, the second CPM 1553, the third CPM 1555, and the Nth CPM 1557, to perform a scanning operation in response to the request by the user. At least one of the first CPM 1551, the second CPM 1553, the third CPM 1555, and the fourth CPM 1557 may access a corresponding cloud service among a first cloud service 1570, a second cloud service 1575, a third cloud service 1580, and a fourth cloud service 1585 to perform a scanning operation. One or more of the first cloud service 1570, the second cloud service 1575, the third cloud service 1580, and the fourth cloud service 1585 may store a cloud file that may be requested to be used by a corresponding CPM.

More specifically, when the CPM control unit 1530 requests the first CPM 1551, the second CPM 1553, the third CPM 1555, and the Nth CPM 1557 to perform a scanning operation, the first CPM 1551 may scan a first cloud file of the first cloud service 1570, the second CPM 1553 may scan a second cloud file of the second cloud service 1575, the third CPM 1555 may scan a third cloud file of the third cloud service 1580, and the Nth CPM 1557 may scan an Nth cloud file of the Nth cloud service 1585, respectively.

The first CPM 1551 may obtain first file information 1591 by scanning the first cloud file stored in the first cloud service 1570. The first CPM 1551 may store the first file information 1591 in an empty scanning file to create a first scanning file 1541. The first CPM 1551 may store the first scanning file 1541 in a virtual folder storage unit 1540. The first scanning file 1541 corresponding to the first cloud file of the first cloud service 1570 may be stored in the virtual folder storage unit 1540.

The second CPM 1553 may obtain second file information 1593 by scanning the second cloud file stored in the second cloud service 1575. The second CPM 1553 may store the second file information 1593 in an empty scanning file to create a second scanning file.

The third CPM 1555 may obtain third file information 1595 by scanning the third file stored in the third cloud service 1580. The third CPM 1555 may store the third file information 1595 in an empty scanning file to create a third scanning file.

The Nth CPM 1557 may Nth obtain file information 1597 by scanning the Nth file stored in the Nth cloud service 1585. The Nth CPM 1557 may store the Nth file information 1597 in an empty scanning file to create an Nth scanning file.

The created scanning files may be integratedly managed by the virtual folder storage unit 1540.

The data managing unit 1520 may create an empty scanning file. The first CPM 1551, the second CPM 1553, the third CPM 1555, and the Nth CPM 1557 may access a cloud file of the corresponding cloud service, which may include the first cloud service 1570, the second cloud service 1575, the third cloud service 1580, and the Nth cloud service 1585 to obtain corresponding file information. The obtained file information may be stored or included in a scanning file.

Further, at least one of the first CPM 1551, the second CPM 1553, the third CPM 1555, and the Nth CPM 1557 may obtain general file information, for example, a file size, a file type, a file created time, an owner, and the like.

The at least one of the first CPM 1551, the second CPM 1553, the third CPM 1555, and the Nth CPM 1557 may set a value of a file availability field to “file available”, and may set a value of a download file path field to “file absent”.

The at least one of the first CPM 1551, the second CPM 1553, the third CPM 1555, and the Nth CPM 1557 may set an identity value of the corresponding CPMs in a CPM index field for one or more scanning files. For example, when the scanning file 1541 is created by the first CPM 1551, the identity value of the first CPM 1551 may be set in the CPM index field of the first scanning file 1541. An identity value of the first cloud service may be set as the identity value of the first CPM 1551. In an example, the identity value of the CPMs may be a name of the corresponding cloud service, an ID and a password, a randomly generated number or alphanumeric characters, or a user designated values, which may be mapped to the corresponding cloud service.

When a request to perform a reading and downloading operation is inputted, the CPM control unit 1530 may request at least one of the first CPM 1551, the second CPM 1553, the third CPM 1555, and the Nth CPM 1557 to read and download the cloud file from the corresponding cloud service using the CPM index field.

When at least one of the first cloud service 1570, the second cloud service 1575, the third cloud service 1580, and the Nth cloud service 1585 perform a scanning operation, at least one of the first CPM 1551, the second CPM 1553, the third CPM 1555, and the Nth CPM 1557 may store characteristic information generated in the first CPM 1551, the second CPM 1553, the third CPM 1555, and the Nth CPM 1557 in a cloud based information field.

Subsequently, the at least one of the first CPM 1551, the second CPM 1553, the third CPM 1555, and the Nth CPM 1557 may access a corresponding cloud file by using the cloud based information field.

The at least one of the first CPM 1551, the second CPM 1553, the third CPM 1555, and the Nth CPM 1557 may transmit its corresponding scanning file to the virtual folder storage unit 1540. The virtual folder storage unit 1540 may store the scanning file in one of its virtual folders. The virtual folder may be classified based on a predetermined standard or may be configured according to user directions. For example, the predetermined standard may include, without limitation, at least a type of the cloud service, and a data type of the cloud file.

The virtual folder storage unit 1540 may report, to the data managing unit 1520, that the scanning file has been received. The data managing unit 1520 may display the scanning file through the I/O user interface 1510. The user may check the file stored in at least one of the first cloud service 1570, the second cloud service 1575, the third cloud service 1580, and the Nth cloud service 1585 by checking the scanning file outputted through the I/O user interface 1510.

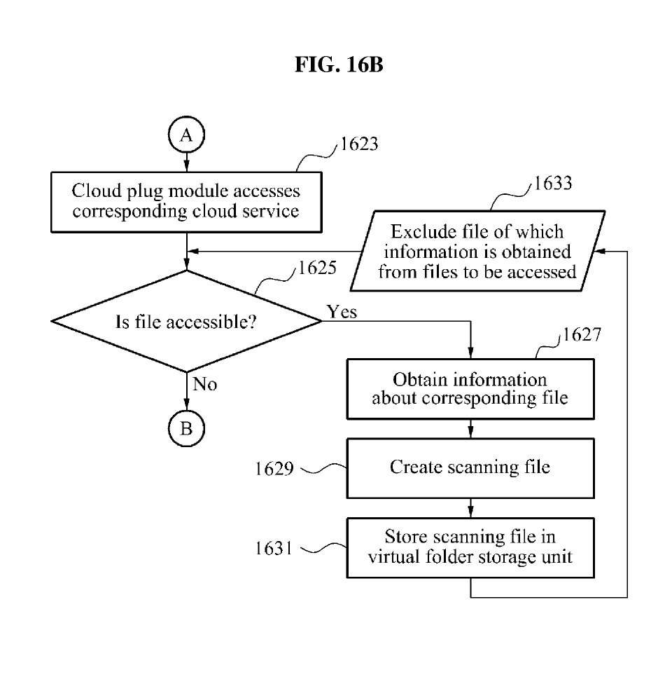

FIG. 16A and FIG. 16B are flowcharts illustrating a cloud service access method according to an exemplary embodiment of the present invention. More specifically, FIG. 16A and FIG. 16B illustrate the scanning operation of the cloud service access apparatus 1500 of FIG. 15. While the scanning operation of FIG. 16A and FIG. 16B below will be described as if performed by the cloud service access apparatus 1500 of FIG. 15, it is not limited as such. In FIG. 16A and FIG. 16B, \textcircled{a}, \textcircled{b}, \textcircled{c}, \textcircled{d}, \textcircled{e} and \textcircled{f} may correspond to at least one of a data flow, a request flow, and a user interface flow of FIG. 15.

In operation 1611, the cloud service access apparatus 1500 may receive a scanning request input through the I/O user interface 1510.

In operation 1613, the data managing unit 1520 may request the CPM control unit 1530 to perform a scanning operation.

In operation 1615, the CPM control unit 1530 may request at least one of the first CPM 1551, the second CPM 1553, the third CPM 1555, and the Nth CPM 1557 registered in the CPM control unit 1530 to perform a scanning operation. Subsequent operation may proceed through subset of operations illustrated in FIG. 16B, which is illustrated with a connecting branch A. The subset of operations illustrated in FIG. 16B will be described more in detail below.

In operation 1617, the at least one of the first CPM 1551, the second CPM 1553, the third CPM 1555, and the Nth CPM 1557 may perform a scanning operation.

In operation 1619, after the scanning operation is completed, the virtual folder storage unit 1540 may report that a scanning file has been created to the data managing unit 1520. The virtual folder storage unit 1540 may store the scanning file in a hierarchical structure in a virtual folder. However, aspects of the invention are not limited thereto, such that the scanning file may be stored without a particular structure, in a group structure, or other organizational structures.

In operation 1621, the cloud service access apparatus 1500 may display a virtual folder in which the scanning file may be stored through the I/O user interface 1510. The hierarchical structure of the virtual folder may be displayed through I/O user interface 1510.

Referring to FIG. 16B, in operation 1623, the at least one of the first CPM 1551, the second CPM 1553, the third CPM 1555, and the Nth CPM 1557 may access the at least one of the first cloud service 1570, the second cloud service 1575, the third cloud service 1580, and the Nth cloud service 1585.

In operation 1625, the at least one of the first CPM 1551, the second CPM 1553, the third CPM 1555, and the Nth CPM 1557 may determine whether a cloud file accessible from the respective cloud service is present or absent. When the cloud file is determined to be absent, the process may move to a branch B and performs operations recited in FIG. 16A. When the accessible file is determined to be present, the process may proceed to operation 1627.

In operation 1627, the at least one of the first CPM 1551, the second CPM 1553, the third CPM 1555, and the Nth CPM 1557 may obtain information of the corresponding file.

In operation 1629, the first CPM 1551, the second CPM 1553, the third CPM 1555, and the Nth CPM 1557 may store the obtained information in an empty scanning file to create a scanning file having the stored file information.

In operation 1631, the first CPM 1551, the second CPM 1553, the third CPM 1555, and the Nth CPM 1557 may store the created scanning file in the virtual folder storage unit 1540. The scanning file may be stored in one of the virtual folders included in the virtual folder storage unit 1540.

In operation 1633, the at least one of the first CPM 1551, the second CPM 1553, the third CPM 1555, and the Nth CPM 1557 may exclude the target file, of which information is already obtained, from files to be accessed.

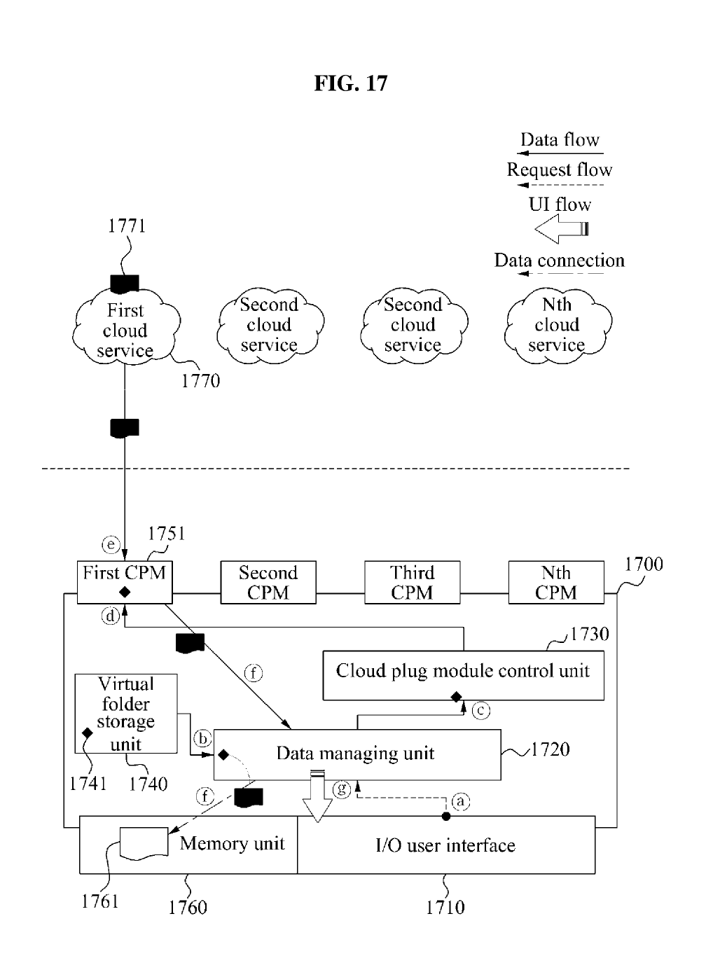

FIG. 17 is a diagram illustrating a downloading operation according to an exemplary embodiment of the present invention.

Referring to FIG. 17, the cloud service access apparatus 1700 may download a copy of a cloud file 1771, the cloud file 1771, or information associated with the cloud file 1771 stored in a first cloud service 1770 using a scanning file 1741, may store the downloaded copy of the cloud file 1771 or information associated with the cloud file 1771 in the memory unit 1760 as a local file 1761, and may connect the scanning file 1741 to the local file 1761 stored in the memory unit 1760. Although a copy of a cloud file, the cloud file itself, or information associated with the cloud file may be downloaded, the specification will be described as downloading the cloud file, but aspects are not limited thereto.

When a request to download the cloud file 1771 is inputted by a user through an I/O user interface 1710, a data managing unit 1720 may download the corresponding scanning file 1741 from a virtual folder storage unit 1740.

The user may not need to distinguish the scanning file 1741 from the cloud file 1771. When a request to download the scanning file 1741 is inputted through the I/O user interface 1710, the data managing unit 1720 may recognize the request to download the scanning file 1741 as a request to download the cloud file 1771 corresponding to the scanning file 1741. However, aspects are not limited thereto, such that the request to download the scanning file 1741 may be submitted in response to meeting a reference condition, or automatically initiated when running an application or a program.

The data managing unit 1720 may determine a value of a file availability field of the scanning file 1741 to determine whether the scanning file 1741 is available. When the scanning file 1741 is determined to be available, the data managing unit 1720 may determine whether a download file path is set.

When a download file path is determined not to be set, the data managing unit 1720 may request the CPM control unit 1730 to download the cloud file 1771 by transmitting the scanning file 1741 to the CPM control unit 1730.

The CPM control unit 1730 may identify that the first CPM 1751 is the corresponding CPM to be requested for downloading the cloud file 1771. The identification of the first CPM as the corresponding CPM may be determined by checking a CPM index field of the scanning file 1741.

The CPM control unit 1730 may request the first CPM 1751 to download the cloud file 1771 by transmitting the scanning file 1741 to the first CPM 1751.

The first CPM 1751 may download the cloud file 1771 of the first cloud service 1770 as a local file 1761 using a cloud based information field of the scanning file 1741.

When the cloud file 1771 is downloaded, the first CPM 1751 may transmit the cloud file 1771 to the data managing unit 1720. The data managing unit 1720 may store the cloud file 1771 in a memory unit 1760 as a local file 1761, and may store a path to the local file 1761 stored in the memory unit 1760. The path to the local file 1761 may be included in the download file path field of the scanning file 1741.

When a request for reading the cloud file 1771 is inputted by the user through the I/O user interface 1710, the data managing unit 1720 may check the download file path of the scanning file 1741 and may search for the local file 1761 stored in the memory unit 1760, in which the local file 1761 may correspond to the cloud file 1771. The data managing unit 1720 may display the local file 1761 through the I/O user interface 1710.

More specifically, when the scanning file 1741 is connected to the local file 1761, the data managing unit 1720 may output the stored local file 1761 through the I/O user interface 1710 without downloading the cloud file 1771.

When the file availability field of the scanning file 1741 is set to a value “file absent”, the data managing unit 1720 may delete the scanning file 1741 from the virtual folder storage unit 1740 and may display the absence of the cloud file 1771 through the I/O user interface 1710.

When it is determined that the cloud file 1771 is absent, the data managing unit 1720 may change a value of the file availability field of the scanning file 1741 to “file absent”.

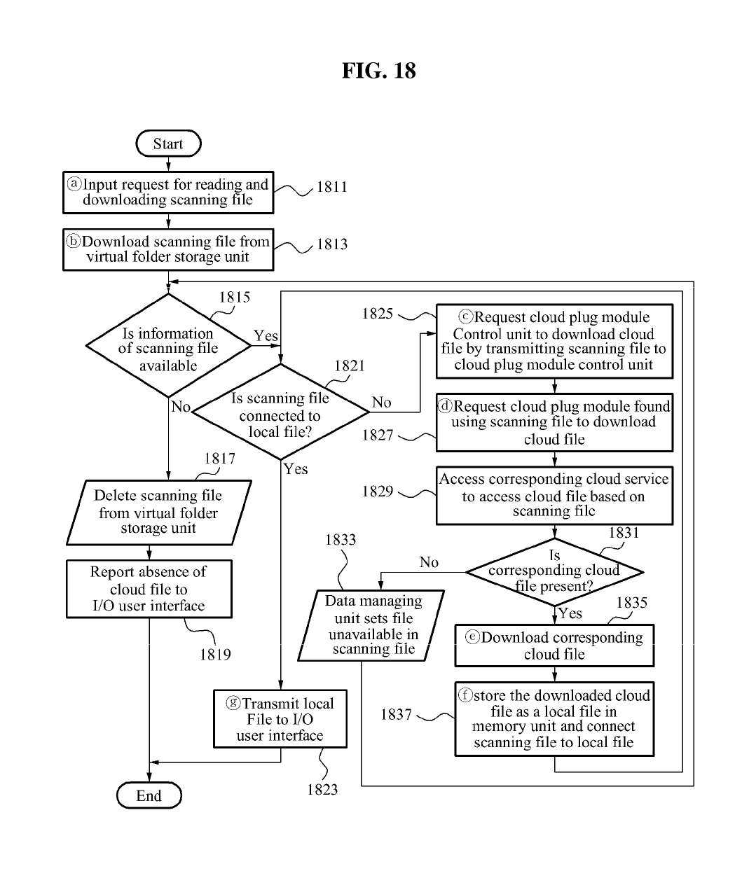

FIG. 18 is a flowchart illustrating a cloud service access method according to an exemplary embodiment of the present invention. More specifically, FIG. 18 illustrates a reading and downloading operation of the cloud service access apparatus 1700 of FIG. 17. While the reading and downloading operation of FIG. 18 below will be described as if performed by the cloud access apparatus 1700 of FIG. 17, it is not limited thereto. In FIG. 18, \textcircled{a}, \textcircled{b}, \textcircled{c}, \textcircled{d}, \textcircled{e}, \textcircled{f}, and \textcircled{g} may correspond to a data flow, a request flow, and a user interface flow of FIG. 17.

In operation 1811, the cloud service access apparatus 1700 receives a request for reading and/or downloading a scanning file, through the I/O user interface 1710. However, aspects of the invention are not limited thereto, such that the cloud service access apparatus 1700 may receive the request through other components or through an external apparatus.

In operation 1813, the data managing unit 1720 may request to download the scanning file from the virtual folder storage unit 1740.

In operation 1815, the data managing unit 1720 may determine whether a cloud file corresponding to the scanning file is available. The data managing unit 1720 may determine whether cloud file corresponding to the scanning file is available by checking a value of a cloud file availability field. If the cloud file corresponding to the scanning file is available in the corresponding cloud service, the cloud file availability field may have a value of “available”. If the cloud file corresponding to the scanning file is unavailable in the corresponding cloud service, the cloud file availability field may have a value of “unavailable”.

In operation 1817, when the scanning file is determined to be unavailable, the data managing unit 1720 may delete the scanning file stored in the virtual folder storage unit 1740.

In operation 1819, the data managing unit 1720 may transmit a value “cloud file absent” to the I/O user interface 1710. The I/O user interface 1710 may display the value “cloud file absent”.

In operation 1821, when information of the scanning file is determined to be available, the data managing unit 1720 may determine whether the scanning file is connected to a local file. The connection of the scanning file to the local file may correspond to a value set in the download file path field of the scanning file. The local file may refer to a portion of the cloud file, the cloud file itself, or information associated with the cloud file that is downloaded from the cloud service using the scanning file.

In operation 1823, when the scanning file is determined to be connected to the local file, the data managing unit 1720 may search for the corresponding local file in the memory unit 1760 and may transmit the local file to the I/O user interface 1710.

In operation 1825, when the scanning file is determined not to be connected to the local file, the data managing unit 1720 may request the CPM control unit 1730 to download the cloud file by transmitting the scanning file to the CPM control unit 1730.

In operation 1827, the CPM control unit 1730 may identify the CPM index field of the scanning file and may search for a corresponding CPM from which download the cloud file is to be requested. The CPM control unit 1730 may request the CPM to download the cloud file by transmitting the scanning file to the respective CPM.

In operation 1829, the CPM may access the corresponding cloud service to access the cloud file using the cloud based information field of the scanning file.

In operation 1831, the CPM may determine whether the cloud file is present in the accessed cloud service.

In operation 1833, when the cloud file is determined to be absent in the accessed cloud service, the data managing unit 1720 may set a value of the file availability field of the scanning file to “file absent”.

In operation 1835, when the cloud file is determined to be present, the CPM may download the corresponding cloud file.

In operation 1837, when the cloud file is downloaded and stored in the memory unit 1760 as a local file, the CPM may transmit the local file to the data managing unit 1720. Further, the data managing unit 1720 may connect the local file to the scanning file. More specifically, the data managing unit 1720 may set a location, in which the local file is stored in the memory unit 1760, in the download file path field of the scanning file.

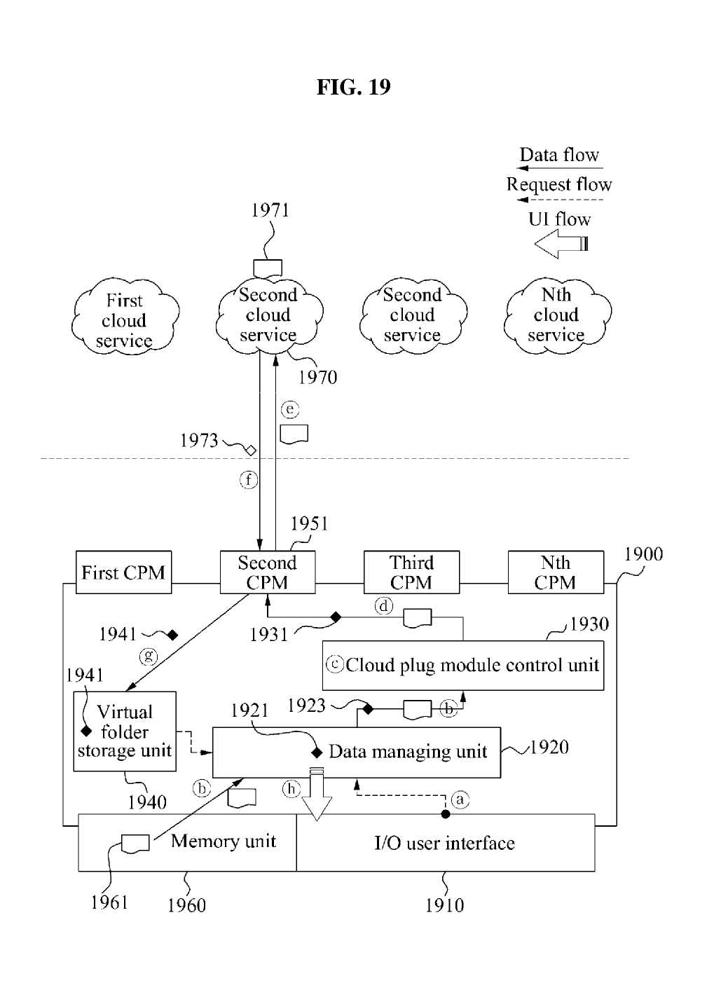

FIG. 19 is a diagram illustrating an uploading operation according to an exemplary embodiment of the present invention.

Referring to FIG. 19, the cloud service access apparatus 1900 may upload a local file 1961 stored in a memory unit 1960 to a second cloud service 1971 on the web.

When an uploading request is inputted by a user through an I/O user interface 1910, a data managing unit 1920 may download the local file 1961 from the memory unit 1960.

The data managing unit 1920 may create an empty scanning file 1921, and may store information associated with the local file 1961 in the empty scanning file 1921. The data managing unit 1920 may request a CPM control unit 1930 to upload the local file 1961 by transmitting a scanning file 1923 including the file information associated with the local file 1961 and the local file 1961 itself, to the CPM control unit 1930.

The CPM control unit 1930 may search for a corresponding cloud service that may be suitable to upload the local file 1961 using a cloud characteristic field. The CPM control unit 1930 may search for a corresponding CPM satisfying a condition in consideration of at least one of a file size, a file type, a data type, and a detailed data type in a file information field of the scanning file 1923. In an example, the detailed data type may refer to a sub-data type of a sub-data included in the data. More specifically, even though multiple files may have a single data type, the respective files may have a different detailed data type. Further, the condition may correspond to at least one of whether the cloud service has a remaining capacity greater than a capacity of the local file 1961, whether the cloud service supports a data type and a detailed data type of the local file 1961, and whether the cloud service is currently able to upload the local file 1961. Further, a cloud service selected by the user through the I/O user interface 1910 may be determined to be a cloud service suitable to upload the local file 1961. In this instance, the CPM control unit 1930 may search for a CPM corresponding to the cloud service selected by the user.

The CPM control unit 1930 may determine a second cloud service 1970 to be a cloud service satisfying the condition, and may request a second CPM 1951, which may correspond to the second cloud service 1970, to upload the local file 1961. The CPM control unit 1930 may update the scanning file 1923 to a scanning file 1931 by setting an identity value of the second CPM 1951 in the CPM information field of the scanning file 1923. The CPM control unit 1930 may transmit the scanning file 1931 and the file 1961 to the second CPM 1951.

The second CPM 1951 may access the second cloud service 1970 to upload the file 1961. When the local file 1961 is uploaded, a copy of the local file 1961 or the original copy of the local file 1961 may be stored in the second cloud service 1970 as a cloud file 1971. The second CPM 1951 may scan the uploaded cloud file 1971. Further, the second CPM 1951 may store information 1973 that may be used to access the second cloud service 1970 in the cloud based information field of the scanning file 1931. When the scanning operation is determined to be complete, the second CPM 1951 may store the scanning file 1941 in the virtual folder storage unit 1940.

The virtual folder storage unit 1940 may report that the scanning file 1941 has been stored to the data managing unit 1920. The data managing unit 1920 may display that the scanning file 1941 has been uploaded, through the I/O user interface 1910. The user may verify whether the file 1961 is uploaded, by checking the scanning file 1941 outputted through the I/O user interface 1910.

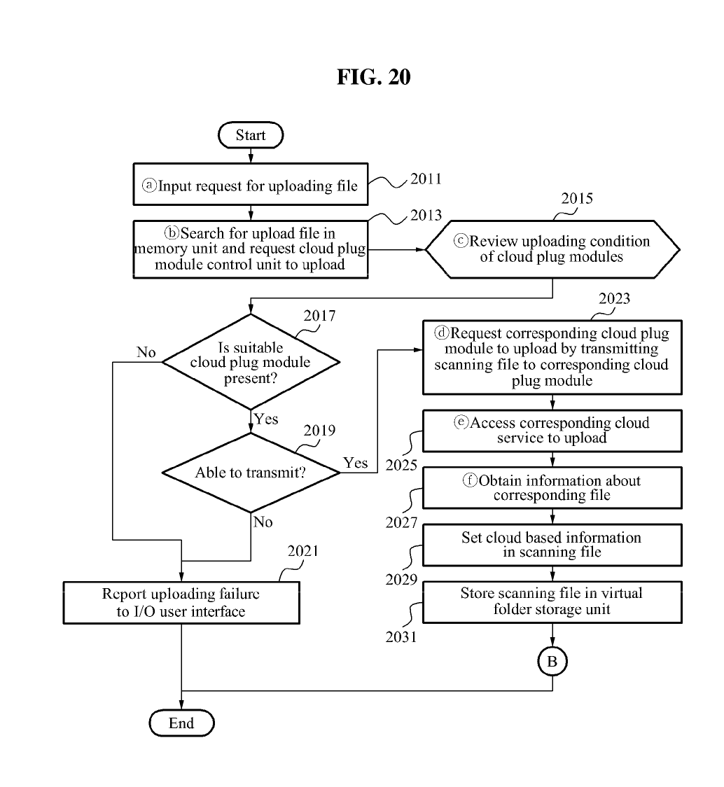

FIG. 20 is a flowchart illustrating a cloud service access method according to an exemplary embodiment of the present invention. More specifically, FIG. 20 illustrates an uploading operation of the cloud service access apparatus 1900 of FIG. 19. While the cloud service access method of FIG. 20 below will be described as if performed by the cloud access apparatus 1900 of FIG. 19, it is not limited thereto. In FIG. 20, \textcircled{a} to \textcircled{f} may correspond to a data flow and a request flow of FIG. 19.

In operation 2011, the cloud service access apparatus 1900 may receive a request for uploading a local file stored in the cloud service access apparatus 1900 through the I/O user interface 1910.

In operation 2013, the data managing unit 1920 may search for the local file to upload in the memory unit 1960 and may request the CPM control unit 1930 to upload the local file. The CPM control unit 1930 may create an empty scanning file, may obtain file information from the upload file, and may store the obtained information in the empty scanning file.

In operation 2015, the CPM control unit 1930 may review one or more uploading conditions of available CPMs. The uploading conditions of the CPMs may be associated with corresponding cloud services. For example, the uploading condition may include storage capacities of the corresponding cloud services, a content type supported by the corresponding cloud services, and a transmission rate of the corresponding cloud services.

In operation 2017, the CPM control unit 1930 may determine whether a CPM suitable for uploading the local file is present.

In operation 2019, when it is determined that the CPM suitable for uploading is present, the CPM control unit 1930 may determine whether the respective CPM is currently able to transmit the local file to the corresponding cloud service. More specifically, the CPM control unit 1930 may determine whether uploading the local file using the suitable CPM can be conducted at this instance.

In operation 2021, when the CPM is unable to transmit the local file to the corresponding cloud service, the CPM control unit 1930 may report that the uploading operation cannot be conducted, to the I/O user interface 1910.

In operation 2023, when the CPM is able to transmit the local file to the corresponding cloud service, the CPM control unit 1930 may request the respective CPM to upload the local file to the corresponding cloud service by transmitting the scanning file to the CPM. An identity value of the corresponding CPM may be set in the CPM index field of the scanning file.

In operation 2025, the CPM may access the corresponding cloud service to upload the local file. When the local file is uploaded to the corresponding cloud service, a copy of the local file or the original copy of the local file may be uploaded and stored in the corresponding cloud service as a cloud file.

In operation 2027, when uploading operation is completed, the CPM may obtain file information of the uploaded cloud file by scanning the uploaded cloud file.

In operation 2029, the CPM may set cloud based information in the scanning file.

In operation 2031, the CPM may store the scanning file in the virtual folder storage unit 1940.

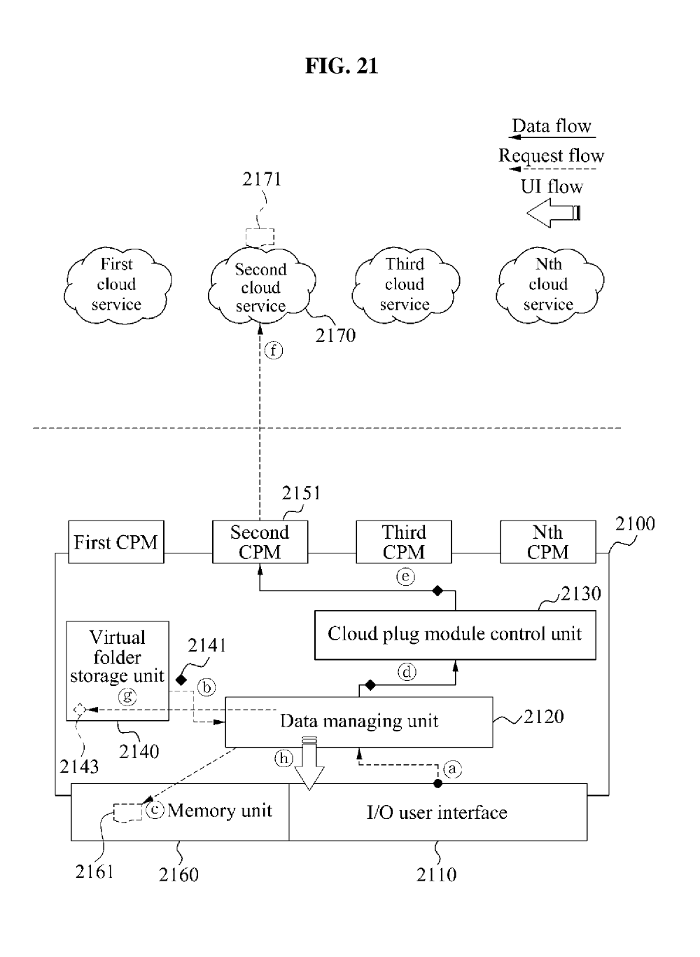

FIG. 21 is a diagram illustrating a deleting operation according to an exemplary embodiment of the present invention.

Referring to FIG. 21, the cloud service access apparatus 2100 may synchronize a memory unit 2160 with a virtual folder storage unit 2140 by deleting a cloud file 2171 stored in a second cloud service 2170 using a scanning file 2141.

When a request for deleting a scanning file 2141 is inputted by a user through an I/O user interface 2110, a data managing unit 2120 may download the scanning file 2141 to be deleted, from the virtual folder storage unit 1740.

The data managing unit 2120 may delete a local file 2161 stored in the memory unit 2160 using a download file path field of the scanning file 2141. The data managing unit 2120 may request a CPM control unit 2130 to delete the cloud file 2171 by transmitting the scanning file 2141 to the CPM control unit 2130.

The CPM control unit 2130 may check a CPM index field of the scanning file 2141 and may search for a second CPM 2151, which may access the cloud file 2171 stored in the corresponding cloud service. The CPM control unit 2130 may request the second CPM 2151 to delete the cloud file 2171 by transmitting the scanning file 2141 to the second CPM 2151.

The second CPM 2151 may access and delete the cloud file 2171 stored in the second cloud service 2170 using the cloud based information field of the scanning file 2141.

When the cloud file 2171 is deleted, the second CPM 2151 may report that deletion of the cloud file 2171 is completed to the data managing unit 2120. The data managing unit 2120 may display a type of the deleted scanning file 2143 using the scanning file 2141. Synchronization may be implemented by deleting some or all of the related files including the scanning file 2141, the cloud file 2171, and the local file 2161.

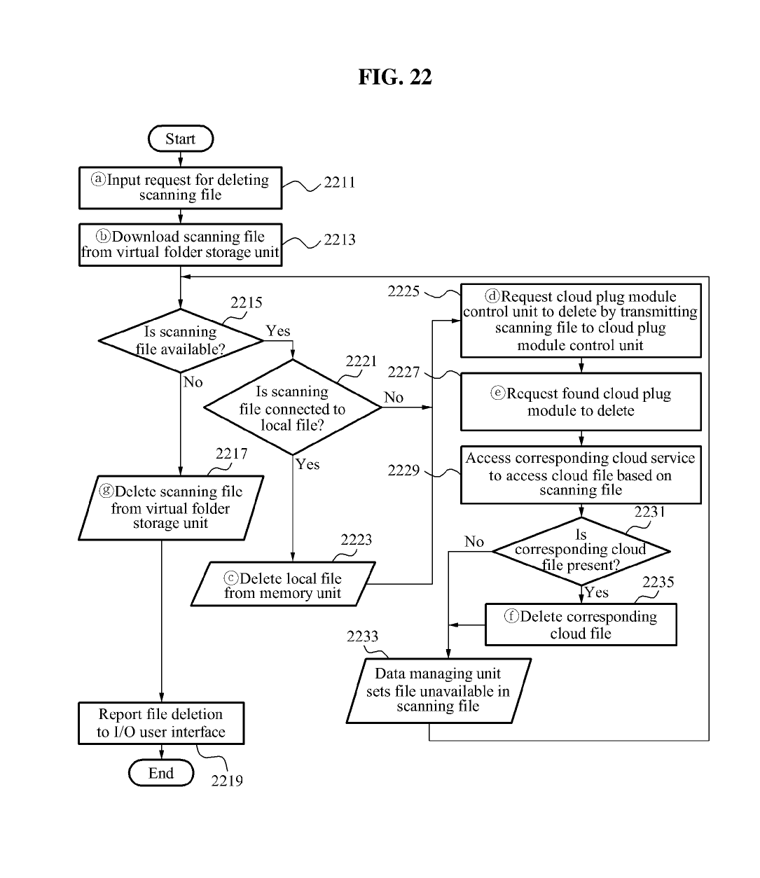

FIG. 22 is a flowchart illustrating a cloud service access method according to an exemplary embodiment of the present invention. More specifically, FIG. 22 illustrates a deleting operation of the cloud service access apparatus 2100 of FIG. 21. While the deleting operation of FIG. 22 below will be described as if performed by the cloud access apparatus 2100 of FIG. 21, aspects are not limited thereto. In FIG. 22, \textcircled{a}, \textcircled{b}, \textcircled{c}, \textcircled{d}, \textcircled{e}, \textcircled{f}, and \textcircled{g} may correspond to a data flow and a request flow of FIG. 21.

In operation 2211, the cloud service access apparatus 2100 may receive a request for deleting a scanning file through the I/O user interface 2110.

In operation 2213, the data managing unit 2120 may download the scanning file to be deleted, from the virtual folder storage unit 2140.

In operation 2215, the data managing unit 2120 may determine whether a cloud file corresponding to the scanning file is available. The data managing unit 2120 may determine whether cloud file corresponding to the scanning file is available by checking a value of a cloud file availability field. If the cloud file corresponding to the scanning file is available in the corresponding cloud service, the cloud file availability field may have a value of “available”. If the cloud file corresponding to the scanning file is unavailable in the corresponding cloud service, the cloud file availability field may have a value of “unavailable”.

In operation 2217, when the information associated with the scanning file is available, the data managing unit 2120 may delete the scanning file from the virtual folder storage unit 2140.

In operation 2219, the data managing unit 2120 may report that the cloud file is absent in the cloud service to the I/O user interface 2110. The I/O user interface 2110 may display that the cloud file is absent.

In operation 2221, when the information of the scanning file is available, the data managing unit 2120 may check whether the scanning file is connected to the local file. The connection of the scanning file to the local file may correspond to a value set in the download file path field of the scanning file.

In operation 2223, when the scanning file is determined to be connected to the local file, the data managing unit 2120 may delete the local file from the memory unit 2160.

In operation 2225, when the scanning file is determined not to be connected to the local file, the data managing unit 2120 may request the CPM control unit 2130 to delete the cloud file stored in the cloud service by transmitting scanning file to the CPM control unit 2130.

In operation 2227, the CPM control unit 2130 may check the plug module index field of the scanning file and may search for a CPM to be requested to delete the cloud file. The CPM control unit 2130 may request the CPM to delete the cloud file by transmitting the scanning file to the corresponding CPM.

In operation 2229, the CPM may access the corresponding cloud service to access the cloud file using the cloud based information field of the scanning file.

In operation 2231, the CPM may determine whether the cloud file is present in the accessed cloud service.

In operation 2233, when the cloud file is determined to be unavailable, the data managing unit 2120 may set a value of the file availability field of the scanning file to “unavailable”.

In operation 2235, when the cloud file is determined to be present, the CPM may delete the cloud file.

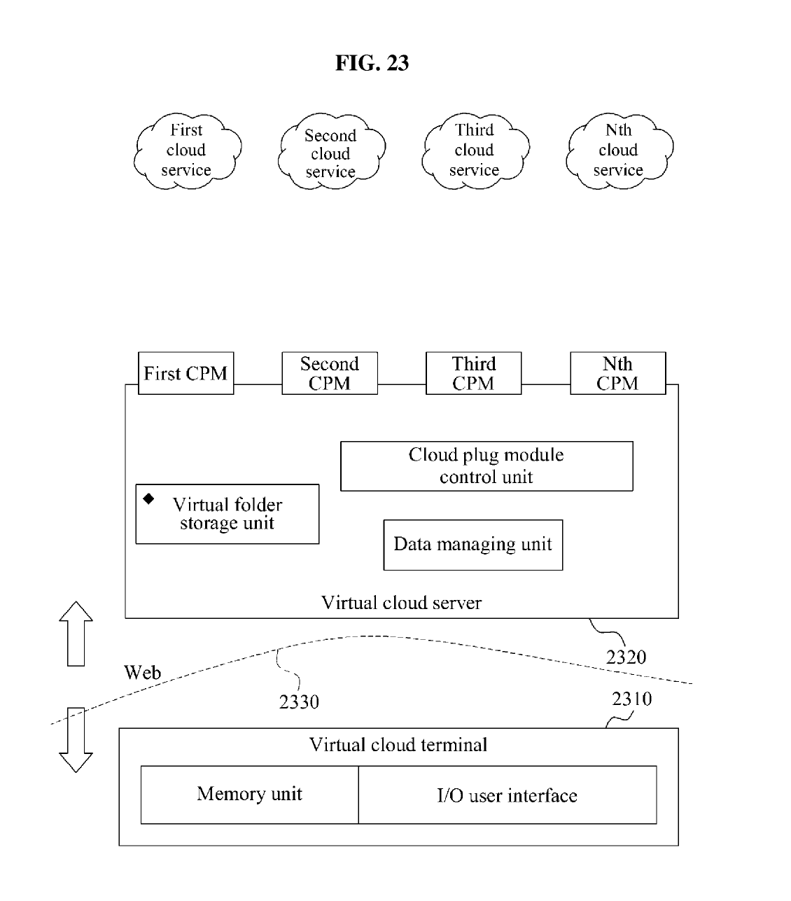

FIG. 23 is a block diagram illustrating a cloud service access system according to an exemplary embodiment of the present invention.

Referring to FIG. 23, the cloud service access system includes a virtual cloud terminal 2310 and a virtual cloud server 2320.

The virtual cloud terminal 2310 includes a memory unit and an I/O user interface. The I/O user interface may include an input unit and an output unit. The input unit may receive a request input to access one or more cloud services. The output unit may output an access result in response to the access request.

The access request may include, without limitation, a scanning request, a reading and downloading request, an uploading request, and a deleting request. After a scanning operation is completed, the output unit may output a scanning file. The outputting operation may refer to or correspond to displaying the scanning file on a display interface. The output unit may output at least one of a downloading result, an uploading result, and a deleting result.

The virtual cloud server 2320 may include a data managing unit, a CPM control unit, a virtual folder storage unit, and a cloud service access unit. The cloud service access unit may include a plurality of CPMs, including a first CPM, a second CPM, a third CPM, and an Nth CPM.

The cloud service access unit may access one or more cloud services based on information associated with the scanning file.

The data managing unit may create the scanning file or update an existing scanning file based on the access request. The CPM control unit may control the cloud service access unit based on the information associated with the scanning file.

The virtual cloud terminal 2310 may be physically separated from the virtual cloud server 2320 or integrated together. If the virtual cloud terminal 2310 is physically separated from the virtual cloud server 2320, the virtual cloud terminal 2310 may be connected to the virtual cloud server 2320 via a network. The virtual cloud terminal 2310 may store a local file in the memory unit and request access to the local file through the I/O user interface. The virtual cloud server 2320 may process one or more operations by performing an operation associated with management of the scanning file. In an example, the virtual cloud server 2320 may be configured to perform one or more operations of the virtual cloud terminal 2310 to reduce a burden imposed on the virtual cloud terminal 2310.

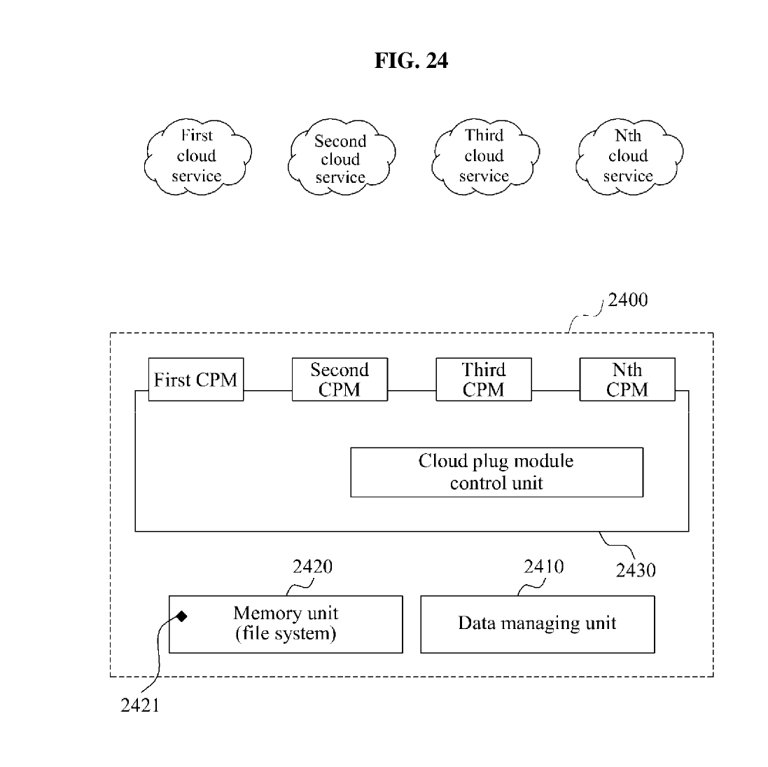

FIG. 24 is a block diagram illustrating a cloud service access apparatus 2400 according to another exemplary embodiment of the present invention.

Referring to FIG. 24, the cloud service access apparatus 2400 may be mounted in a terminal. However, aspects of the invention are not limited thereto, such that the cloud service access apparatus 2400 may be mounted in an external device to be accessed by a network.

A scanning file 2421 may be stored in a memory unit 2420. The memory unit 2420 may correspond to a file system of an operating system included in the terminal. A data managing unit 2410 may be implemented as an additional operation of a file browser of the operating system. When the scanning file 2421 is stored in the file system and the data managing unit 2410 is controlled by the file browser of the operating system, the scanning file 2421 may be treated like a general file in the operating system without operating a separate application.

A cloud service management unit 2430 including a CPM control unit and a plurality of CPMs. The plurality of CPMs include a first CPM, a second CPM, a third CPM, and an Nth CPM. The cloud service management unit 2430 may be mounted in the operating system of the terminal.

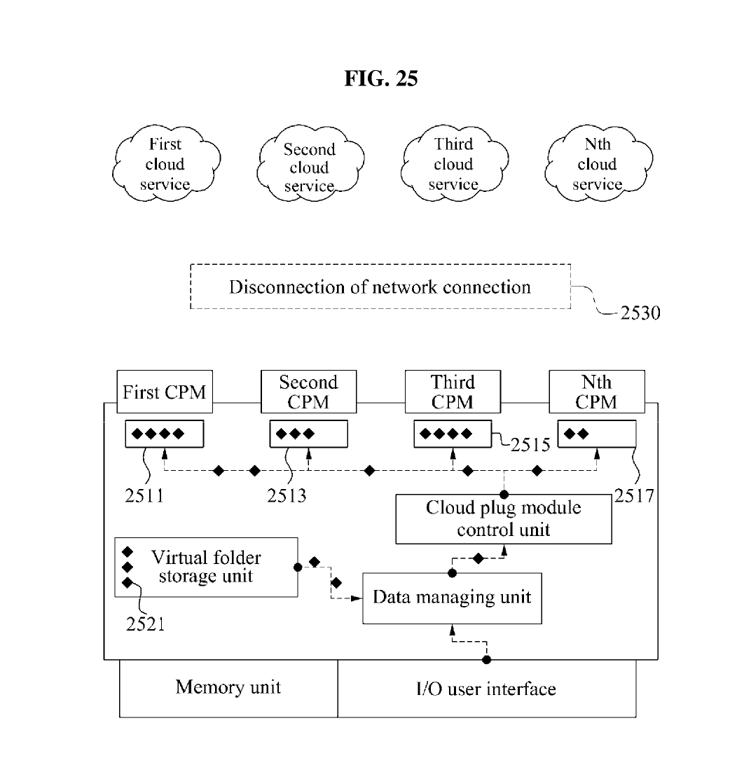

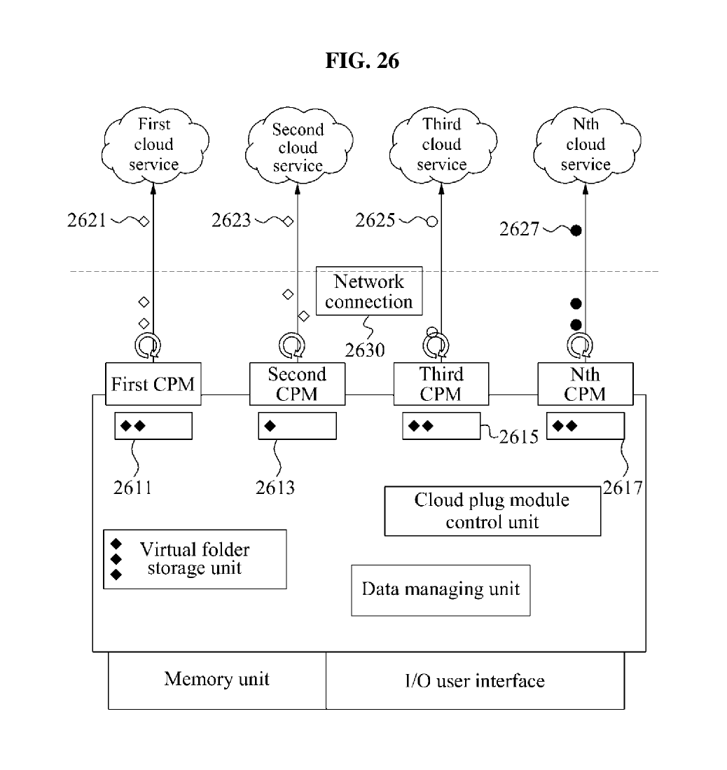

FIG. 25 and FIG. 26 are block diagrams illustrating a cloud service access apparatus according to an exemplary embodiment of the present invention.

Referring to FIG. 25, in a situation 2530 in which a network connection between a cloud service and the cloud service access apparatus is disconnected, the cloud service access apparatus may perform an operation to access the cloud service using at least one of a first memory 2511, a second memory 2513, a third memory 2515, and an Nth memory 2517 assigned to each CPM.

The at least one of the first memory 2511, the second memory 2513, the third memory 2515, and the Nth memory 2517 may store a scanning file 2521 corresponding to one or more access requests stored in a queue. More specifically, when an operation is requested when the network connection is disconnected, the respective operation may be placed in a queue to be processed. As an example, a queue may be used with respect to at least one of the first memory 2511, the second memory 2513, the third memory 2515, and the Nth memory 2517. The queue may correspond to a buffer to store a predetermined number of files or codes, in which a first inputted file may be outputted last. Also, as an example, a stack may be used with respect to at least one of the first memory 2511, the second memory 2513, the third memory 2515, and the Nth memory 2517. The stack may correspond to a buffer to store a predetermined number of files or codes, in which a last inputted file may be outputted first

When an operation request, which may be stored in a queue, is assigned to a CPM, the cloud service access apparatus may perform a secondary operation when a network connection is disconnected.

An operation of transmitting a scanning file 2521 from a data managing unit to the CPM may be performed when a network connection is disconnected.

The network connection may be used to connect between the CPM and the cloud service to perform one or more operations.

When the operation request is stored in a queue and assigned to the CPM, the respective operation request may be processed even when the network connection is disconnected. When the network connection of the cloud service access apparatus is reestablished, the CPM may dequeue the scanning file from at least one of a first operation request queue 2611, a second operation request queue 2613, a third operation request queue 2615, and an Nth operation request queue 2617 to perform at least one of a first operation 2621, a second operation 2623, a third operation 2625, and an Nth operation 2627, as shown in FIG. 26.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media, such as hard discs, floppy discs, and magnetic tape; optical media, such as CD ROM discs and DVD; magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

The exemplary embodiments of the present invention may provide a method that may access various cloud services using a single client interface or software including one or more CPMs corresponding to one or more cloud services, thereby reducing a number of dedicated client interfaces or software to correspond each cloud service.

Also, the exemplary embodiments of the present invention may enable content sharing between cloud services using an integrated virtual cloud, thereby facilitating the expansion of a client interface or software to a new cloud service.

Also, the exemplary embodiments of the present invention may output various contents present in various cloud services with one user interface, which may improve the usability and utility of the cloud services.

Also, the exemplary embodiments of the present invention may access at least one of a plurality of cloud services with a terminal with a low memory capacity by using a scanning file.

Also, the exemplary embodiments of the present invention may search for information associated with a cloud file using general file information of a scanning file and may access at least one of a plurality of cloud services using cloud file information and CPM information of the scanning file.

Also, a scanning file, which may be stored in a terminal, may have information associated with a cloud file. Thus, a file information search may be conducted in a case in which a network connection to a cloud service is disconnected.

Also, since a scanning file corresponding to a cloud file to be deleted and a scanning file of a cloud file to be downloaded are classified and stored in a virtual folder storage unit based on file information of a scanning file, when a network connection satisfies a predetermined standard, a deleting operation and a downloading operation may be performed quickly.

Also, application data of which a cloud file is absent may be read in a file format using an application data field of a scanning file.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling a cloud file using a processor, comprising:
determining, using the processor, whether a scanning file corresponding to the cloud file is available;
obtaining the scanning file from a virtual folder storage unit of a terminal;
identifying a cloud plug module (CPM) corresponding to a cloud service in which the cloud file is stored based on the scanning file; and
accessing the cloud service through the CPM.

2. The method of claim 1, wherein the scanning file is generated by:
scanning the cloud service comprising the cloud file;
obtaining information associated with the cloud file;
creating the scanning file based on the information associated with the cloud file; and
storing the scanning file in the virtual folder storage unit of a terminal.

3. The method of claim 1, further comprising:
downloading the cloud file, a portion of the cloud file, or information associated with the cloud file as a local file when the cloud file is determined to be stored in the cloud service; and
connecting the scanning file to the local file.

4. The method of claim 1, further comprising:
setting a value for a cloud file availability field of the scanning file as unavailable when the cloud file is determined to be unavailable in the cloud service; and
deleting the scanning file from the virtual folder storage unit.

5. The method of claim 1, further comprising:
deleting the cloud file when the cloud file is determined to be stored in the cloud service;
setting a value for a cloud file availability field of the scanning file as unavailable when the cloud file is determined to be unavailable in the cloud service; and
deleting the scanning file from the virtual folder storage unit.

6. The method of claim 1, wherein, when a cloud file availability field of the scanning file is determined to be unavailable, the scanning file is deleted from the virtual folder storage unit.

7. The method of claim 1, further comprising:
determining whether the scanning file is connected to a local file,
wherein the local file is the cloud file, a portion of the cloud file, or information associated with the cloud file that is downloaded from the cloud service using the scanning file.

8. The method of claim 7, further comprising:
transmitting the local file to an interface of the terminal when the scanning file is determined to be connected to the local file.

9. The method of claim 7, further comprising:
deleting the local file from the memory unit when the scanning file is determined to be connected to the local file.

10. The method of claim 1, wherein the scanning file comprises at least one of file information, CPM information, cloud based information, and application data.

11. The method of claim 10, wherein the file information comprises general file information and cloud file information.

12. The method of claim 11, wherein the cloud file information comprises information associated with file availability or a download file path.

13. The method of claim 10, wherein the CPM information comprises a CPM index, the CPM index comprising an identity of the CPM corresponding to the cloud file.

14. The method of claim 1, further comprising:
placing a request for performing an operation in the cloud service in a queue in the CPM for processing when a network connection between the CPM and the corresponding cloud service is disconnected.

15. A method for uploading a local file, comprising:
receiving a request for uploading the local file to a cloud service;
determining whether a suitable cloud plug module (CPM) is present based on an upload condition;
transmitting a first scanning file to the CPM; and
accessing the cloud service via the CPM for uploading the local file.

16. The method of claim 15, further comprising:
obtaining file information of the uploaded local file by scanning the uploaded local file;
setting cloud based information in the scanning file using the obtained file information; and
storing the scanning file in a virtual folder storage unit.

17. The method of claim 15, wherein the upload condition comprises at least one of a file size, a file type, a data type, and a detailed data type.

18. A cloud service access apparatus, comprising:
a cloud service access unit comprising a cloud plug module (CPM);
a virtual folder storage unit to store a scanning file associated with the CPM; and
a control unit to determine whether the scanning file corresponds to a cloud file, to obtain the scanning file from a virtual folder storage unit, to identify the CPM corresponding to a cloud service storing the cloud file based on the scanning file, and to access the cloud service through the CPM.

19. The cloud service access apparatus of claim 18, wherein the control unit:
scans the cloud service comprising the cloud file;
obtains information associated with the cloud file;
creates the scanning file based on the information associated with the cloud file; and
stores the scanning file in the virtual folder storage unit.

20. The cloud service access apparatus of claim 18, further comprising a memory unit to store a local file,
wherein the local file is the cloud file, a portion of the cloud file, or information associated with the cloud file that is downloaded from the cloud service using the scanning file.

21. The cloud service access apparatus of claim 18, wherein the scanning file comprises at least one of file information, CPM information, cloud based information, and application data.

22. The cloud service access apparatus of claim 21, wherein the file information comprises general file information and cloud file information.

23. The cloud service access apparatus of claim 22, wherein the cloud file information comprises information associated with file availability or a download file path.

24. The cloud service access apparatus of claim 21, wherein the CPM information comprises CPM index comprising an identity a CPM corresponding to the requested cloud file.

25. The cloud service access apparatus of claim 18, wherein the control unit queues a request to perform an operation in the cloud service in the CPM when a network connection between the CPM and the corresponding cloud service is disconnected.
